(19) United States
(12) Patent Application Publication
(10) Pub. No.: US 2026/0288503 A1
(43) Pub. Date: Sep. 24, 2026

(54) SYSTEMS AND METHODS FOR MACHINE LEARNING-BASED EXECUTION OF SOFTWARE CODE FROM SCIENTIFIC OR TECHNICAL DOCUMENTS IN A VIRTUAL ENVIRONMENT

(71) Applicants: Constructor Technology AG, Schaffhausen (CH); Constructor Education and Research Genossenschaft, Schaffhausen (CH)

(72) Inventors: Alexander PLAKUNOV, Sofia (BG); Ivan TSYGANOV, Neuchatel (CH); Andrey ADASCHIK, Istanbul (TR); Alexander TORMASOV, Busingen am Hochrhein (DE); Laurent DEDENIS, Geneve (CH); Stanislav PROTASOV, Singapore (SG); Serg BELL, Singapore (SG); Nikolay DOBROVOLSKIY, Alanya (TR)

(21) Appl. No.: 19/084,872

(22) Filed: Mar. 20, 2025

(51) Int. Cl. G06F 9/455; G06F 21/56

(52) U.S. Cl. CPC G06F 9/45504; G06F 9/45558; G06F 21/563

(57) ABSTRACT

Disclosed herein are systems and method for executing software code associated with scientific or technical documents in a virtual environment. The method may include: receiving a document and software code associated with the document; analyzing document and/or software code using a first trained machine learning (ML) model to identify hardware, software and/or runtime configuration parameters for execution of the software code; configuring the virtual environment based at least on the identified configuration parameters; executing the software code in the virtual environment and collecting an execution log of the software code; and in the event the software code fails to execute correctly, analyzing the execution log using a second trained MLM to identify configuration parameters of the virtual environment associated with a cause of failure in execution of the software code, modifying the identified configuration parameters of the virtual environment, and executing the software code in the modified virtual environment.

he present disclosure relates to the field of machine learning, and, more specifically, to systems and methods for machine learning (ML)-assisted analysis of executing and troubleshooting execution of scientific or technical documents in a virtual environment.

BACKGROUND [0002]n the rapidly evolving landscape of setting up computing environments for academic projects, the traditional approach of manually linking scientific articles and their accompanying code or computational workflows is proving to be increasingly ineffective and cumbersome. The traditional approach is typically time-consuming and requires careful attention to detail to ensure that the computing environment is properly configured and that there is a clear correspondence between parameters mentioned in the scientific text and those used in the software code for analysis. [0003]s an example workflow, take a researcher working on replicating a deep learning experiment based on a scientific article that describes a convolutional neural network (CNN) for classification. First, the researcher must review the scientific article to identify key parameters and to understand the computational processes and techniques applied in a methods section of the scientific article. In this way, the researcher manually extracts information from the article describing the architecture of the CNN (e.g., number of layers, types of activation functions, etc.) as well as training parameters like batch size, learning rate, and the dataset used. Next, the research must locate and install software and tools, and any other required libraries by following instructions. The researcher may use a virtual environment to manage dependencies. This requires the researcher to inspect the code to find the variables and configurations that correspond to the descriptions in the paper. Parameters such as initial conditions, learning rates, or iteration counts may be manually adjusted in configuration files or script headers to match the experimental setup described in the article. This ensures that the code matches the experimental conditions described in the text. In addition, scientific research often involves specific datasets (e.g., publicly available data, proprietary data, or data generated through experiments). The research again must manually download and preprocess these datasets to ensure they align with the conditions described in the article. [0004]owever, configuring and setting up virtual environments can be a complex and challenging process due to the interplay of software, hardware, and runtime configurations. Software configurations often involve managing dependencies, library versions, and compatibility issues, requiring careful coordination to avoid conflicts. Hardware configurations add another layer of difficulty, as the environment must be tailored to the specific capabilities of the underlying infrastructure, such as CPU architecture, GPU compatibility, or memory constraints. Runtime configurations, including environment variables and execution settings, further complicate the process, as they demand precise adjustments to ensure the virtual environment functions seamlessly. This multifaceted complexity highlights the need for meticulous planning and troubleshooting to achieve a stable virtual environment setup.

SUMMARY [0005]o address the shortcomings of configuring virtual environments to run code attached to scientific or technical documents in a virtual environment, the present disclosure describes training machine learning (ML) models to identify hardware, software, and/or runtime configuration parameters for execution of software code associated with the scientific or technical documents. Specifically, the present disclosure describes automating the setup and configuration of virtual environments tailored for scientific or technical research projects by leveraging artificial intelligence (AI) models to efficiently select and configure the necessary configurations, parameters, resources, and/or services to execute the software code. In addition, if the software code fails to execute correctly in the configured virtual environment, then a machine learning model (MLM) will analyze the execution log to troubleshoot and modify the configuration parameters of the virtual environment. [0006]ome of the technical improvements of the present disclosure include automating and optimizing the setup of virtual environments for executing software code associated with a scientific or technical document. In this way, the present disclosure eliminates the need for manual configuration, saving time and reducing human error, while ensuring efficient allocation of hardware and software resources. The use of MLMs guarantees compatibility by dynamically selecting the necessary configurations, mitigating errors, and troubleshooting execution issues through log analysis. This process not only enhances execution success, but also supports scalability, allowing the system to adapt to diverse projects and handle complex dependencies seamlessly. Additionally, the present disclosure improves reproducibility by ensuring consistent configurations and logging fixes for future references. By automating environment setup and addressing configuration challenges, the system lowers the technical barrier for users, making advanced computing tools more accessible. It also saves time and cost by minimizing setup time and reducing downtime caused by configuration errors. With the ability to analyze and resolve issues dynamically, the system ensure smooth code execution, while its adaptive learning capabilities refine the process over time. [0007]n one exemplary aspect, a method for executing software code associated with scientific or technical documents in a virtual environment is disclosed. The method includes receiving a scientific or technical document and software code associated with the document, wherein the software code includes executable code and/or source code; analyzing the document and/or software code using a first prepared machine learning (ML) model to identify hardware, software and/or runtime configuration parameters for execution of the software code; configuring the virtual environment based at least on one or more identified configuration parameters; executing the software code in the virtual environment and collecting an execution log of the software code; and in the event the software code fails to execute correctly, analyzing the execution log using a second prepared MLM to identify configuration parameters of the virtual environment associated with a cause of failure in execution of the software code, modifying the identified configuration parameters of the virtual environment, and executing the software code in the modified virtual environment. [0008]n one aspect, the techniques described herein relate to a method, further comprising: displaying the execution log on a user interface (UI). [0009]n one aspect, the techniques described herein relate to a method, further comprising: prior to analyzing the document and/or software code using the first prepared MLM, accessing a database containing a plurality of previously analyzed documents and associated software codes with known hardware, software and/or runtime configuration parameters; comparing, using a third prepared trained MLM, the document and/or software code with the previously analyzed documents and/or software codes to identify a similar document and/or software code in the database and the associated known configuration parameters; and configuring the virtual environment based at least in part on one or more of the known configuration parameters of the similar software code from the database. [0010]n one aspect, the techniques described herein relate to a method, wherein the first and second MLMs include Large Language Models (LLM). [0011]n one aspect, the techniques described herein relate to a method, wherein the third MLM includes an autoencoder or a transformer-based model. [0012]n one aspect, the techniques described herein relate to a method, wherein the virtual environment includes an isolated, secure virtual environment, including one of a container or a virtual machine. [0013]n one aspect, the techniques described herein relate to a method, wherein configuring the virtual environment based at least on the identified hardware, software and/or runtime configuration, includes: identifying and loading into the virtual environment one or more software libraries necessary for execution of the software code. [0014]n one aspect, the techniques described herein relate to a method, wherein executing the software code comprises: checking the software code for malware and/or security vulnerabilities; and based on a determination that the software code contains malware and/or serious security vulnerabilities, terminating execution of the software code. [0015]ccording to one aspect of the disclosure, a system is provided for executing software code associated with scientific or technical documents in a virtual environment, the system including: at least one memory; and at least one hardware processor coupled with the at least one memory and configured, individually or in combination, to: receive a scientific or technical document and software code associated with the document, wherein the software code includes executable code and/or source code; analyze the document and/or software code using a first prepared MLM to identify hardware, software and/or runtime configuration parameters for execution of the software code; configure the virtual environment based at least on one or more identified configuration parameters; execute the software code in the virtual environment and collecting an execution log of the software code; and in the event the software code fails to execute correctly, analyze the execution log using a second prepared trained MLM to identify configuration parameters of the virtual environment associated with a cause of failure in execution of the software code, modify the identified configuration parameters of the virtual environment, and execute the software code in the modified virtual environment. [0016]n one exemplary aspect, a non-transitory computer readable medium storing thereon computer executable instructions for executing software code associated with scientific or technical documents in a virtual environment, including instructions for: receiving a scientific or technical document and software code associated with the document, wherein the software code includes executable code and/or source code; analyzing the document and/or software code using a first prepared MLM to identify hardware, software and/or runtime configuration parameters for execution of the software code; configuring the virtual environment based at least on one or more identified configuration parameters; executing the software code in the virtual environment and collecting an execution log of the software code; and in the event the software code fails to execute correctly, analyzing the execution log using a second prepared MLM to identify configuration parameters of the virtual environment associated with a cause of failure in execution of the software code, modifying the identified configuration parameters of the virtual environment, and executing the software code in the modified virtual environment. [0017]he above simplified summary of example aspects serves to provide a basic understanding of the present disclosure. This summary is not an extensive overview of all contemplated aspects, and is intended to neither identify key or critical elements of all aspects nor delineate the scope of any or all aspects of the present disclosure. Its sole purpose is to present one or more aspects in a simplified form as a prelude to the more detailed description of the disclosure that follows. To the accomplishment of the foregoing, the one or more aspects of the present disclosure include the features described and exemplarily pointed out in the claims.

### BRIEF DESCRIPTION OF THE DRAWINGS

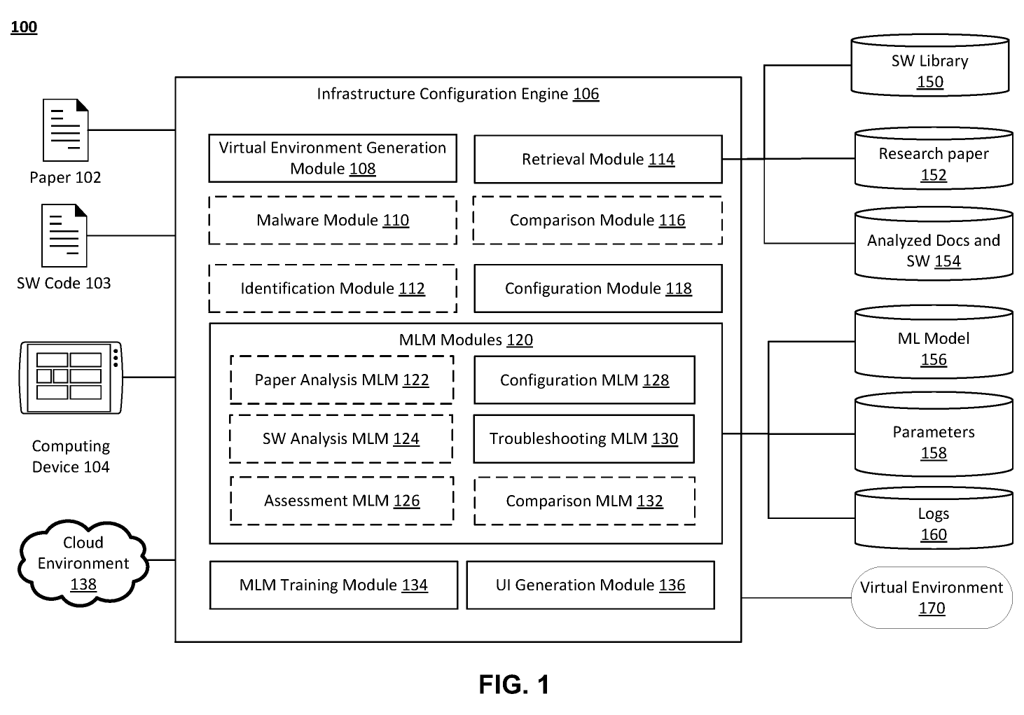

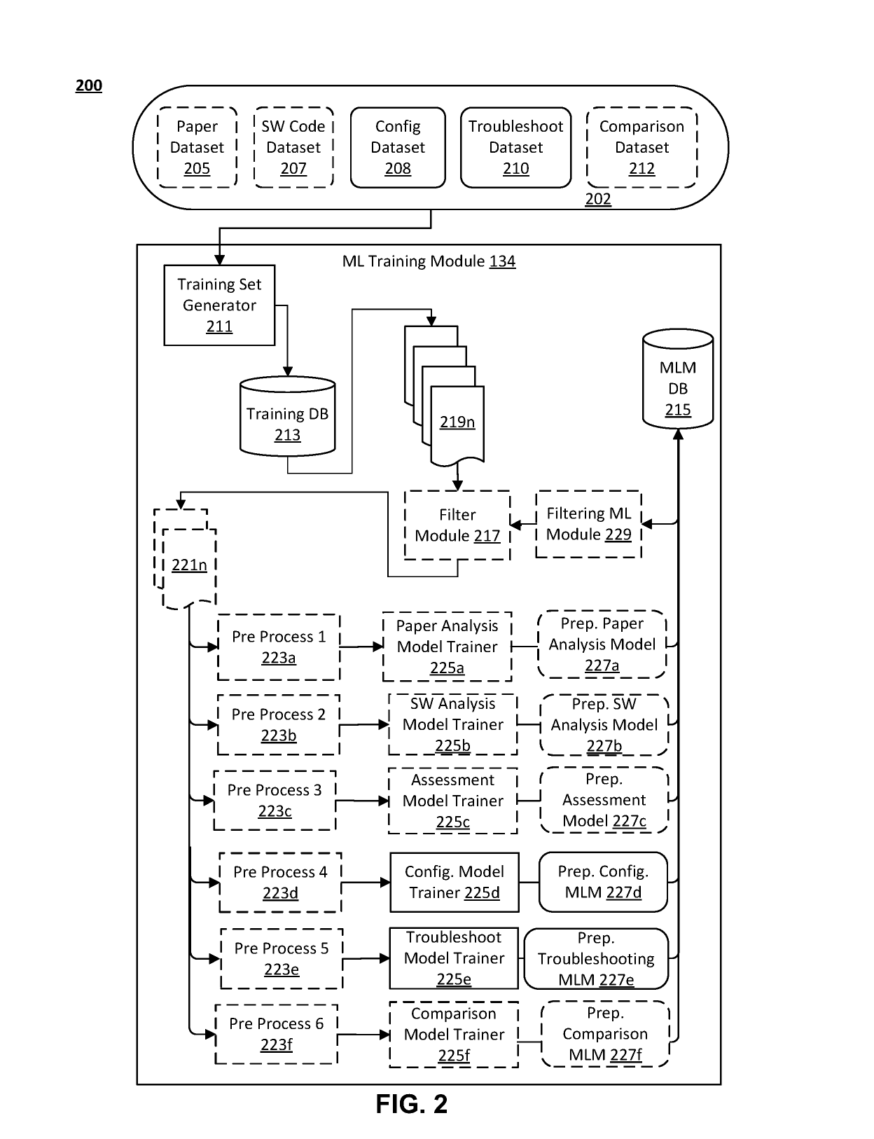

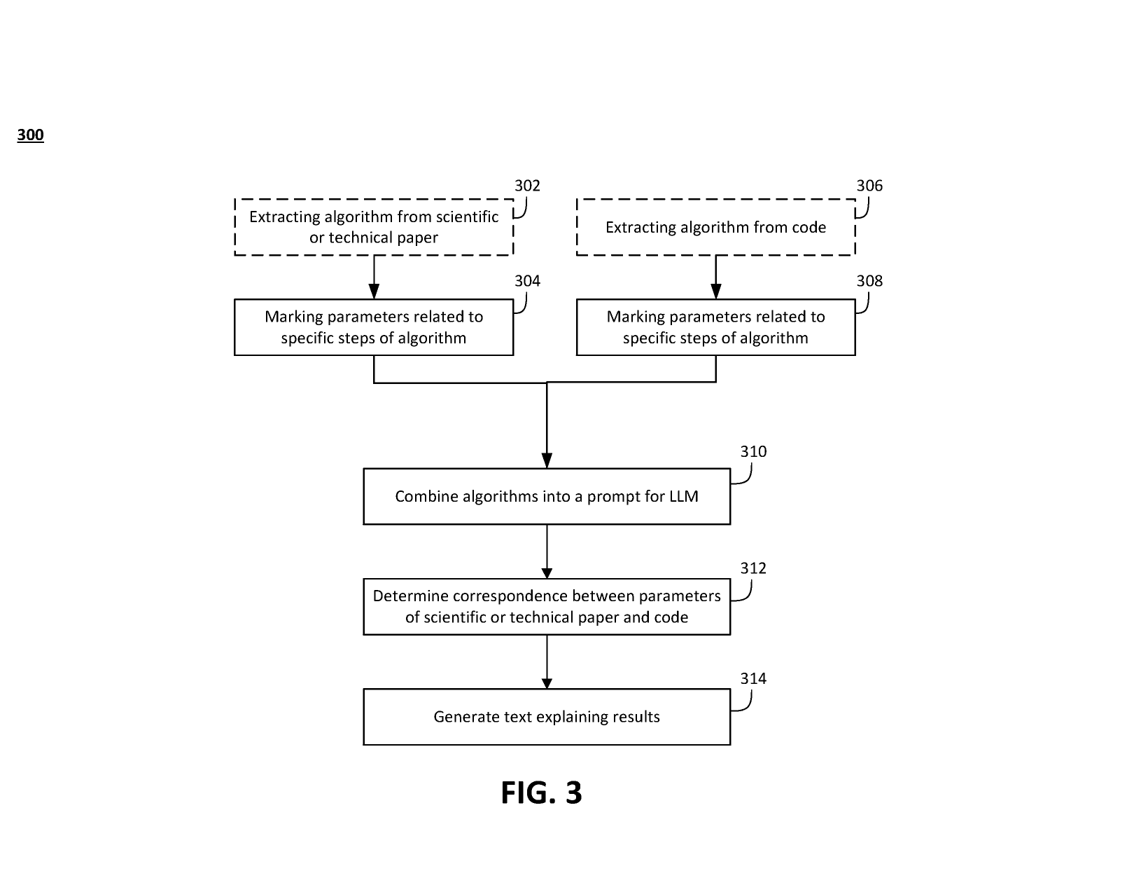

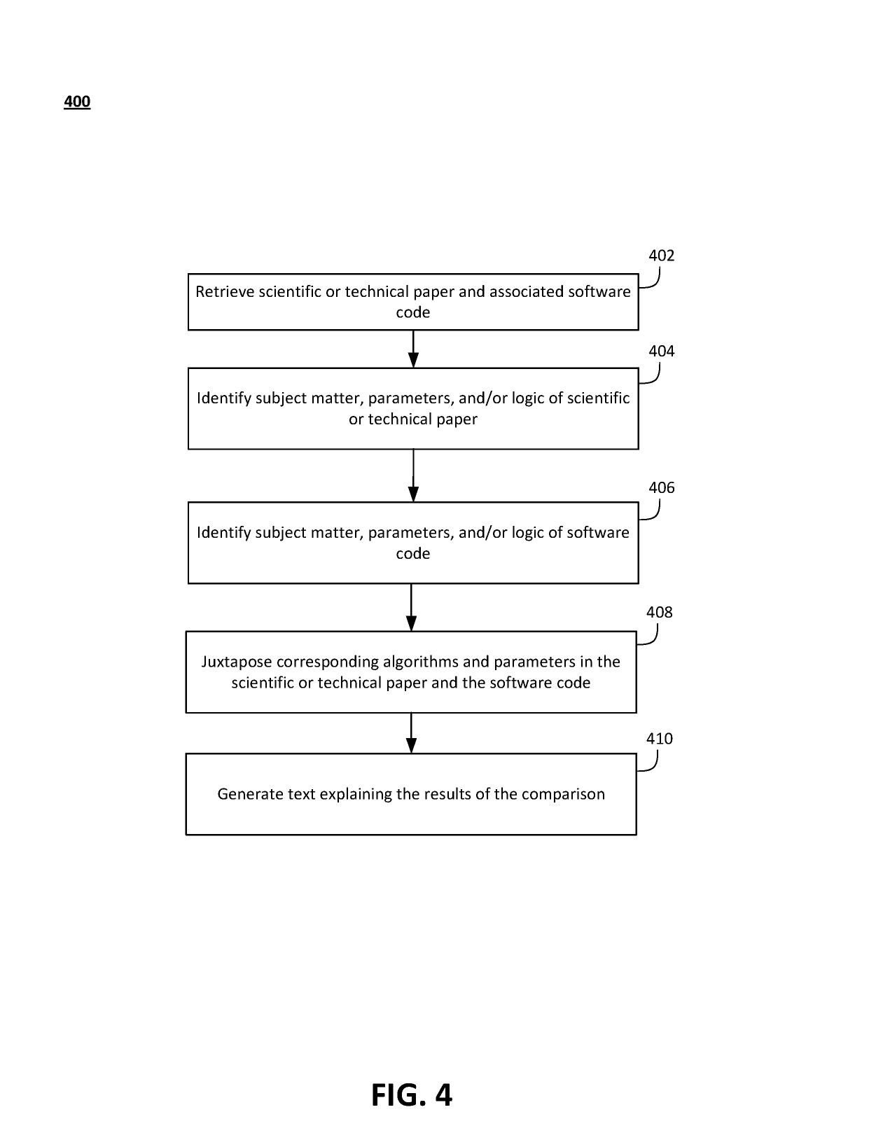

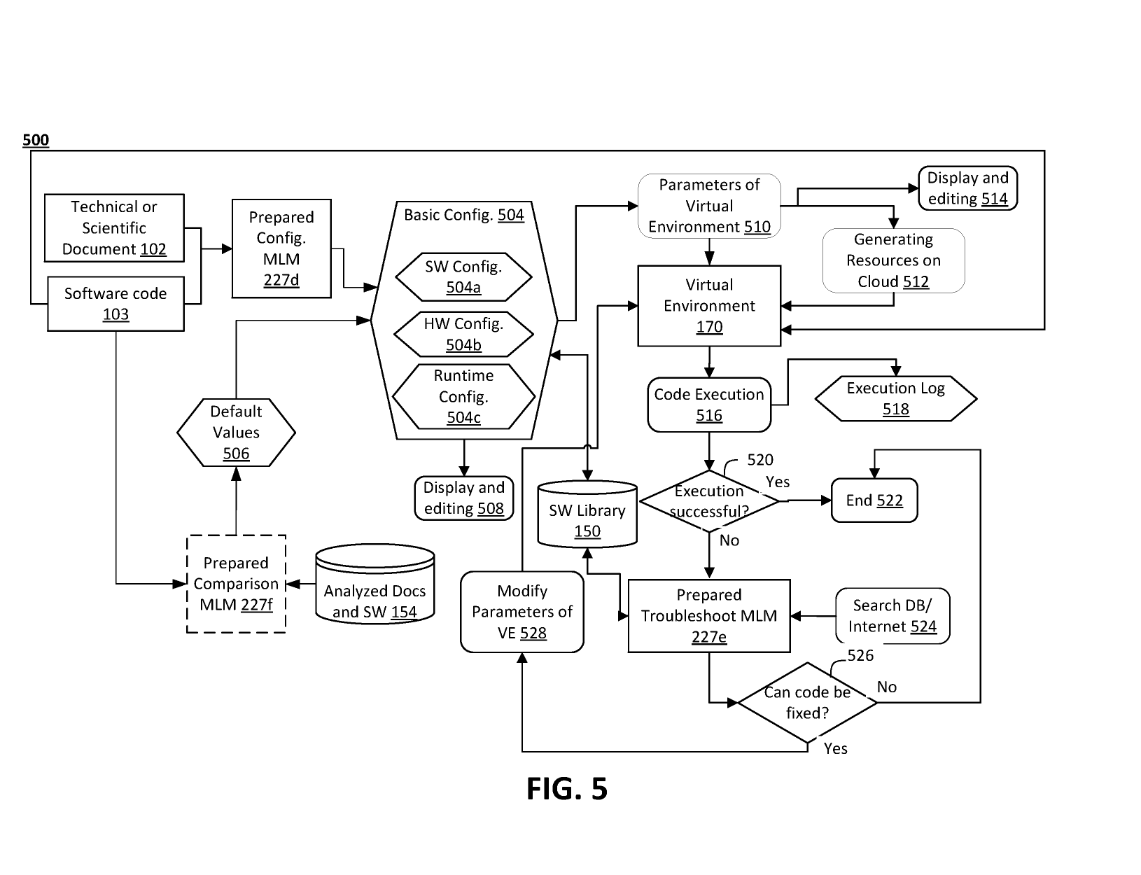

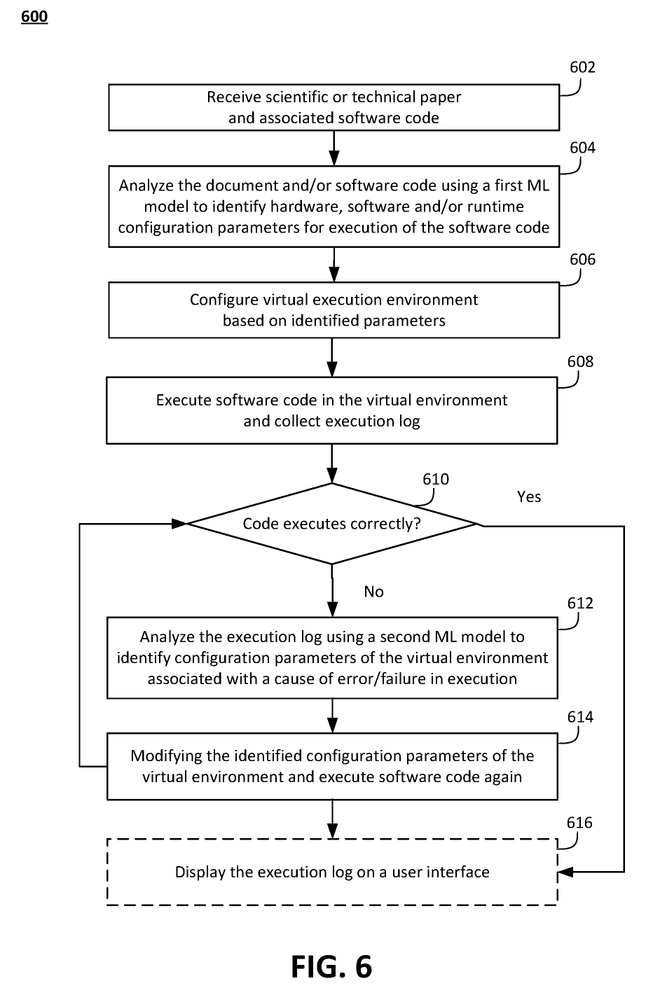

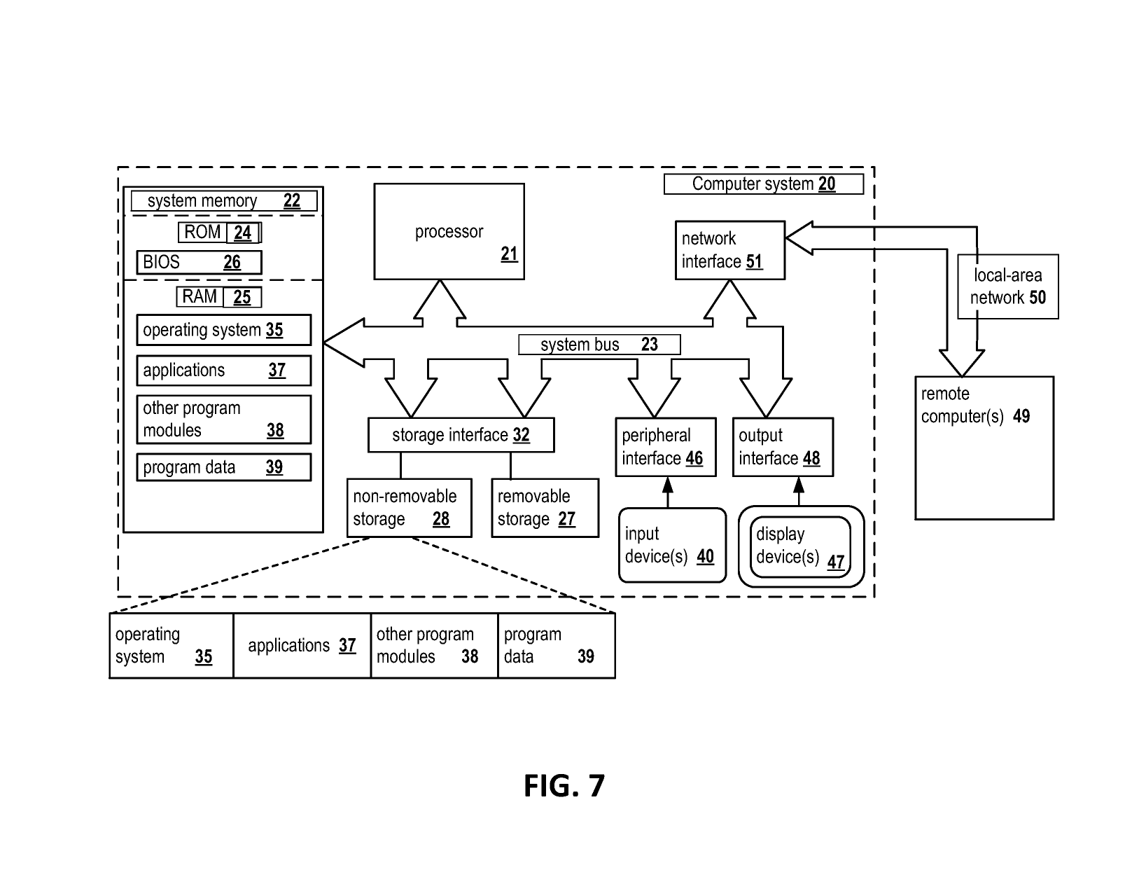

he accompanying drawings, which are incorporated into and constitute a part of this specification, illustrate one or more example aspects of the present disclosure and, together with the detailed description, serve to explain their principles and implementations. FIG. 1s a block diagram illustrating a system for implementing an artificial intelligence (AI) assistance infrastructure configuration engine according to aspects of the present disclosure. FIG. 2 s a block diagram illustrating a system for training machine learning models to identify configuration parameters for execution of the software code according to aspects of the present disclosure. FIG. 3s a first flow diagram of a method for machine learning (ML)-based analysis of scientific or technical documents and associated software code according to aspects of the present disclosure. FIG. 4s a second flow diagram of a method for machine learning (ML)-based analysis of scientific or technical documents and associated software code according to aspects of the present disclosure. FIG. 5 s a low diagram of a method for executing software code associated with scientific or technical documents in a virtual environment according to aspects of the present disclosure. FIG. 6 llustrates an example of a method executing software code associated with scientific or technical documents in a virtual environment in accordance with aspects of this disclosure. FIG. 7 resents an example of a general-purpose computer system on which aspects of the present disclosure can be implemented. ike reference numbers and designations in the various drawings indicate like elements.

### DETAILED DESCRIPTION

xemplary aspects are described herein in the context of a system, method, and computer program product for machine learning (ML)-based execution of software code from scientific or technical documents in a secure computing environment. Those of ordinary skill in the art will realize that the following description is illustrative only and is not intended to be in any way limiting. Other aspects will readily suggest themselves to those skilled in the art having the benefit of this disclosure. Reference will now be made in detail to implementations of the example aspects as illustrated in the accompanying drawings. The same reference indicators will be used to the extent possible throughout the drawings and the following description to refer to the same or like items. he present describes various aspects of machine learning (ML) based execution of software code from scientific or technical documents in a secure virtual environment. One aspects involves using ML to analyze a scientific or technical document to identify hardware, software, and/or runtime configuration parameters for execution of software code associated with the scientific or technical document. A second aspect involves using ML to identify configuration parameters of the virtual environment associated with a cause of failure in execution of the software code. A third aspect involves using ML to compare the documents and/or software code with previously analyzed documents and/or software codes to identify a similar document and/or software code in the database and the associated known configuration parameters. scientific or technical document may have software code associated with it for several reasons, depending on the nature of the research and its field. A fundamental principle of scientific research is reproducibility, which requires that other researchers can replicate the results presented in a study. Sharing computer code fosters transparency, allowing others to verify the findings or expand upon the research. In many scientific and engineering disciplines, researchers may use complex models and simulations that are developed as part of the study. Providing the software code also ensures that other researchers can run these simulations under similar conditions to understand the models better, validate the results, or test them against different datasets. In addition, many scientific or technical documents may involve the analysis of large datasets. Computer code may be provided to show how data was processed, analyzed, or visualized. Furthermore, code associated with scientific or technical documents provides a reference for how the authors implemented a particular algorithm or method. This is particularly important in cases where the method’s details may be too complex to describe fully in text, or where small differences in implementation might significantly affect the results. It should be noted that the invention is not limited to scientific or technical documents, but includes any type of research paper, or the like. owever, validating software code associated with scientific or technical documents in virtual environments presents a number of challenges. irst, the manual setup of identifying hardware, software, and/or runtime configuration parameters for the execution of the software code in a virtual environment is time-consuming and prone to user errors, especially when researchers (who may not have a technical background or experience in computer programming) need to identify and configure the configuration parameters. Automation streamlines this process, allowing researchers to focus on the core scientific tasks instead of setting up and configuring the computing environment. By automating the setup and implementation of virtual environments, researchers may easily and reliably recreate computing environments. In this way, collaboration and sharing of results may be accelerated, ensuring that the research described in the scientific or technical documents can be easily replicated by others. econd, automation guarantees that the same environment is set up consistently, reducing variability between experimental runs due to mismatched software versions or configuration errors. Automated setup systems can ensure that all experiments adhere to certain standards or protocols, increasing the scientific rigor of the research. Software code may be written in a specific environment (e.g., specific operating systems, libraries, or versions of dependencies), and without detailed documentation. Variations in hardware, software, and/or runtime configurations may lead to inconsistent results. hird, leveraging AI to select and configure the necessary tools ensures that only the essential resources are deployed, optimizing computational resources and reducing waste. For example, AI can determine the best cloud instances, hardware accelerators (GPUs or TPUs) or storage solutions for specific tasks. AI may dynamically adjust the configuration parameters based on project requirements or ongoing experimental needs, improving the efficiency of high-performing computing environments. ourth, modern research, particularly in fields like genomics, astrophysics, and AI, often involves large-scale datasets and complex computational workflows. AI-driven automation can streamline and orchestrate these workflows, ensuring that all dependencies are met and the correct parameters are applied to each stage of the analysis. As machine learning and AI become central to many fields, automated setups can ensure that most optimal configuration parameters are correctly configured, reducing the burden on researchers unfamiliar with these tools. utomating the setup of configuration parameters for execution of the software code, especially when combined with AI for configuration parameter selection, management, and troubleshooting, enables faster, more reliable research. In addition, the present disclosure optimizes resource usage, facilitates collaboration, and ensures that the experiments are conduced in well-tuned, error-free environments. This kind of automation is increasingly essential in modern scientific inquiry, where complexity, data, and computational demands continue to grow exponentially. t should be noted that the present disclosure describes utilizing a computing environment for analyzing research projects based on scientific articles for illustrative purposes only and that the methods and systems described in the present disclosure may be applicable to any activity that involves comparing logic, parameters, and/or algorithms between an academic paper and computer code. As a non-limiting example, the methods and systems described in the present disclosure may be applicable to business papers and computer code. ccordingly, the present disclosure describes a ML-based approach for analyzing documents and software code to identify hardware, software, and runtime configuration parameters necessary for executing the software. By automating the extraction of these configuration parameters, the present disclosure reduces the need for manual identification, thereby improving accuracy, efficiency, and consistency. In this way, the present disclosure enables faster setup and replication of execution environments while minimizing human errors. Additionally, this approach may enhance software deployment by identifying potential compatibility issues early in the development lifecycle and ensuring the correct execution environment. This approach ultimately streamlines software execution, optimizes deployment, and enhances overall system reliability. n addition, the present disclosure also describes a ML-based approach for analyzing the execution log using a second prepared machine learning model (MLM) to identify configuration parameters of the virtual environment associated with a cause of failure in execution of the software code. The present disclosure enhances failure analysis by automating the detection of misconfigurations, compatibility issues, and resource constraints that may lead to execution errors. By leveraging ML to analyze execution logs, the approach also reduces the need for manual debugging, improving efficiency and accuracy in diagnosing failures. In this way, rapid root cause identification, minimizing downtime and accelerating issue resolution may be enabled. It is particularly beneficial in complex or dynamic environments where virtual configurations frequently change, making traditional troubleshooting methods inefficient. urning now to the figures, example aspects are depicted with reference to one or more components described herein, where components in dashed lines may be optional. FIG. 1 s a block diagram illustrating a system 100 for implementing an artificial intelligence (AI) assistance infrastructure configuration engine according to aspects of the present disclosure. The system 100 may include a computing device 104, a scientific or technical document 102, software code 103 associated with the document, and an infrastructure configuration engine 106, which may be a software installed on or accessed (e.g., via a virtual machine, container, web application) on the computing device 104. The computing device 104 allows a user to control and configure the system 100 and view a user interview (UI). Computing device 104 may execute a plurality of modules in the infrastructure configuration engine 106 that together make up a retrieval, recognition, configuration, and troubleshooting system. In some aspects, the infrastructure configuration engine 106 may correspond to a computing device 104 that is configured to execute a plurality of modules that together make up the infrastructure configuration engine 106. haring software code in scientific or technical documents is a way to promote transparency, reproducibility, and collaboration, making it easier for the scientific community to validate, extend, or apply the research. It's particularly common in disciplines involving computational methods, data analysis, and software development. The infrastructure configuration engine 106 may be configured to execute a suitable computational environment with configuration parameters to execute software code 103 associated with a scientific or technical document 102. In addition, the infrastructure configuration engine 106 may be configured to automatically setup and/or optimize the software, hardware, and/or runtime configurations and parameters for a virtual environment 170. Furthermore, the infrastructure configuration engine 106 may also be configured to install and execute any services needed to execute the corresponding software code 103 to validate the results from the documents 102. If the software code 103 does not execute successfully, the infrastructure configuration engine 106 may further be configured to troubleshoot the failure by analyzing an execution log to identify any configuration parameters that may have caused the failure, modifying the configuration parameters of the virtual environment 170, and then re-executing the software code in the modified virtual environment 170. or example, the infrastructure configuration engine 106 may obtain at least one scientific or technical document 102 from a research paper database 152 for analysis and identify configuration parameters (e.g., hardware, software, and/or runtime configuration parameters) for execution of the software code 103. The infrastructure configuration engine 106 may then be configured to determine correspondence between parameters in the text of the article and parameters in the attached software code 103 for reconfiguration and analysis. In addition, if the software code 103 fails to execute correctly, the infrastructure configuration engine 106 may then use a ML to analyze an execution log to identify configuration parameters of the virtual environment associated with a cause of failure in execution of the software code 103. he infrastructure configuration engine 106 may include a virtual environment generation module 108, an optional malware module 110, an optional identification module 112, a retrieval module 114, an optional comparison module 116, a configuration module 118, MLM modules 120 including an optional paper analysis MLM 122, an optional software analysis MLM 124, an optional assessment MLM 126, a configuration MLM 128, a troubleshooting MLM 130, and an optional comparison MLM 132, a MLM training module 134, and a UI generation module 136. The infrastructure configuration engine 106 may be connected to cloud environment 138, a software library database 150, a research paper database 152, an analyzed documents and software database 154, a MLM database 156, a parameters database 158 and/or a logs database 160. n some aspects, these databases may be hosted in the cloud environment 138. In some aspects, the infrastructure configuration engine 106 (specifically, the UI generation module 136) may generate a UI for display on the computing device 104, which may be part of the client application associated with the infrastructure configuration engine 106. For example, the computing device 104 may be a device belonging to an end user such as a research or learner. he computing device 104 may execute a UI (not pictured) to obtain, from the user, a scientific or technical document 102 containing at least software code to run the methods, experiments, and/or tests explained in the document 102 and corresponding parameters in the text of the article. For example, if the scientific or technical document 102 corresponds to a chemistry article, the scientific or technical document 102 may include software code 103 to execute computer simulations to validate the method or experiment in the chemistry article. For many users reading the article, they may not understand the software code 103 in the article due to not being computer savvy or the code may be written in a different programing language. iven the scientific or technical document 102 or a link to the scientific or technical document 102, the MLM modules 120 from the infrastructure configuration engine 106 may generally perform a multi-step process to: (1) understand, compare, and/or validate the results and/or code in the scientific or technical document 102 using trained MLMs (e.g., neural networks, LLMs etc.), (2) understand the logic and parameters of the scientific or technical document 102 and code, (3) dynamically configure the software, hardware, and runtime configurations and configuration parameters for a virtual environment 170, (4) obtain and install needed services for executing the code in the virtual environment 170, (5) troubleshoot the software code by identifying configuration parameters associated with a cause of failure of the software code, and/or (6) modifying the identified configuration parameters and executing the software code in the modified virtual environment 170. n some aspects, the computing device 104 may execute a virtual environment generation module 108 configured to generate a suitable and secure computing virtual environment configured to execute the software code 103 (e.g., C++, Python, MATLAB, etc.) attached to a scientific or technical document 102. In some aspects, the virtual environment generation module 108 may provide a cloud-based container to compare research articles to the code in the articles. In some examples, the virtual environment generation module 108 may provide a virtual machine, a container, a docket container, and/or a sandbox to execute research articles to the code in the articles. ptionally, the computing device 104 may execute the optional malware module 110 configured to check the software code 103 for malware and/or security vulnerabilities. Malware may be defined as code (whether it is part of a script or embedded in a software system) designed to cause damage, security breaches, or other threats to application security. In addition, based on a determination that the software code 103 contains malware and/or security vulnerabilities, the optional malware module 110 may be configured to terminate execution of the software code 103 to protect the system from the malware code. Malware code may cause major disruption to the computer and network since hackers can use the malware code to gain control of computers and passwords may be compromised. n some aspects, the computing device 104 may execute the optional identification module 112 configured to identify subject matter, logic, algorithms, and/or parameters from the scientific or technical document 102. In some aspects, the computing device 104 may execute the optional identification module 112 configured to identify subject matter, logic, algorithms, and/or configuration parameters represented in portions of the software code 103 based on the obtained description of the subject matter, logic, algorithms, and/or configurations parameters from external sources. n addition, the identification module 112 may be configured to identify and load into the virtual environment 170 one or more software libraries necessary for execution of the software code 103. This ensures a smooth execution of software code 103 within the virtual environment 170 by identifying and loading the necessary software libraries. This functionality involves analyzing the code's dependencies, determining the required libraries, and obtaining them for integration into the virtual environment 170. By automating this process, the system 100 eliminates the need for manual intervention, reduces setup time, and ensures compatibility between the code 103 and its dependencies. This capability is particularly significant in complex or dynamic environments, where maintaining consistency and reducing errors are critical for efficient execution and testing. n some aspects, the computing device 104 may execute a retrieval module 114 configured to retrieve a scientific or technical document 102 and a software code 103 associated with the scientific or technical document. The software code 103 may include executable code and/or source code. In some aspects, the retrieval module 114 may access the software library database 150, the research paper database 152, and/or the analyzed documents and software database 154. In some aspects, the retrieval module 114 may obtain a description of the subject matter, logic, algorithms, and/or parameters from external sources. In some aspects, the retrieval module 114 may access the scientific or technical documents 102 and the associated software code 103 from the internet or any other suitable sources. n some aspects, the computing device 104 may execute the optional comparison module 116 configured to identify corresponding algorithms and parameters in the scientific or technical document 102 and the software code 103. Specifically, the optional comparison module 116 may compare subject matter, logic, algorithms, and/or parameters of the scientific or technical document 102 with the subject matter, logic, algorithms, and/or parameters of the associated software code 103 to identify corresponding subject matter, logic, algorithms, and/or parameters between the scientific or technical document 102 and the software code 103. n some aspects, the computing device 104 may execute a configuration module 118 to configure the virtual environment 170 based at least in part on identified configuration parameters. In addition, the configuration module 118 may adjust configuration parameters or values of the configuration parameters in the software code 103 and/or configure the virtual environment 170 based at least in part on identified configuration parameters. Furthermore, the configuration module 118 may generate prompts based on the configuration parameters of the code and create a script for changing parameters of the software code and/or virtual environment 170 either due to experimentation, troubleshooting, or software code failure. After the configuration parameters or values of the parameters are adjusted, the software code 103 and/or virtual environment 170 may be re-executed with the updated configuration parameters and the results are re-analyzed. n some aspects, the computing device 104 may execute a MLM module 120 including an optional paper analysis MLM 122, an optional software analysis MLM 124, an optional assessment MLM 126, a configuration MLM 128, a troubleshooting MLM 130, and/or an optional comparison MLM 132. The optional prepared paper analysis MLM 122 is configured to identify subject matter, algorithms, parameters, and/or logic of the scientific or technical document 102 using a text interpretation LLM. The optional prepared SW analysis MLM 124 is configured to analyze software code associated with the scientific or technical document to also identify subject matter, algorithms, parameters, and/or logic of the software code using software code from a software library database 150. The optional prepared assessment MLM 126 may be configured to assess whether the software code 103 corresponds to the scientific or technical document 102 and generates text explaining the results of the comparison using a text generation LLM. The configuration MLM 128 may be configured to identify hardware, software, and/or runtime configuration parameters for execution of the software code 103 by analyzing the document 102 and software code 103. The troubleshooting MLM 130 may be configured to identify configuration parameters of the virtual environment 170 associated with a cause of failure in execution of the software code 103 based on an execution log. The optional comparison MLM 132 may be configured to compare the document 102 and/or software code 103 with previously analyzed documents and/or software code from the analyzed documents and software database 154 to identify a similar document and/or software code in the software library database 150 and the associated known configuration parameters. n some aspects, the optional paper analysis MLM 122, the optional software analysis MLM 124, the optional assessment MLM 126, the configuration MLM 128, the troubleshooting MLM 130, and/or the optional comparison MLM 132 may contain specifically trained MLMs. For illustrative purposes, the present disclosure will describe the MLM as an LLM, but those of ordinary skill in the industry will recognize that any suitable type of MLM may be utilized in the present disclosure. LLM is a type of AI designed to understand and generate human language. LLMs are trained on vast amounts of text data, enabling it to perform a wide range of language-related tasks such as answering questions, summarizing text, translating languages, or generating content. LLMS, similar to GPT (generative pretrained transformer), use deep learning techniques to recognize patterns, learn context, and predict word sequences making them highly versatile in natural language processing applications. Accordingly, the computing device 104 may execute the MLM training module 134 to train the LLMs in the optional paper analysis MLM 122, the optional software analysis MLM 124, the optional assessment MLM 126, the configuration MLM 128, the troubleshooting MLM 130, and/or the optional comparison MLM 132 to teach the MLMs to perform their respective specific tasks. Further details about the training of each respective MLM will be described in FIG. 2. transformer is a deep learning architecture used in large language models (LLMs). The transformer has an encoder/decoder structure with numerous stacked multi-head attention layers and feed forward network layers. This architecture allows the model to process and generate text effectively, capturing long-range dependencies and contextual information. Transformer are well-suited for tasks like natural language processing, and image classification and generation. Common examples of transformer models are generative pre-trained transformer (GPT) and Bidirectional Encoder Representations from Transformers (BERT). or analysis tasks such as analyzing the document 102 and/or software code 103, an unprepared configuration MLM 128 will first analyze data from a configuration training dataset to “learn” how to identify hardware, software, and/or runtime configuration parameters for execution of the software code. As an example, the configuration training dataset may include at least annotated software document that may include technical manuals, user guides, and other descriptive materials that detail system requirements, dependencies, and runtime configurations. This training dataset may be annotated to highlight references to hardware (e.g., CPU, GPU, memory), software (e.g., required libraries, frameworks, and versions), and runtime parameters (e.g., environment variables, configuration options). The configuration training dataset may also include annotated source code that involves samples of code in various programming languages, with annotations identifying elements such as important statements, hardware-specific API calls, and configuration file references. These structured explicitly list the dependencies, runtime setups, and hardware requirements necessary for software execution. In addition, the configuration training dataset may also include log files generated during software execution provide valuable insights into runtime conditions. These files may contain messages about hardware utilization (e.g., GPU memory), software issues (e.g., missing dependencies), and runtime errors (e.g., “out of memory” or “library version mismatch). The annotated logs enable the configuration MLM 128 to recognize patterns indicating configuration requirements. Furthermore, the configuration training dataset may include a diverse range of benchmarks and compatibility matrices that document the relationship between various hardware, software, and runtime configurations and their performance. This helps the configuration MLM 128 generalize across different environments. o further enhance the model's capabilities, unlabeled data, such as large corpora of software documentation and code, can be used for pretraining, allowing the configuration MLM 128 to develop a foundational understanding of technical language and context. Preprocessing these data sources, maintaining a consistent labeling schema, and ensuring a diverse range of programming languages and domains are represented will contribute to building a robust and effective MLM. uring training of the configuration MLM 128, the results from the untrained MLM are then compared with known data set results using the corresponding labels identifying different types of presentation styles and their effectiveness. It should be noted that the input to the trained configuration MLM 128 will be data from the training dataset. or every input training sample from the training dataset, the trained configuration MLM 128 will produce a prediction consisting of values representing a probability that a particular hardware, software, and/or runtime configuration parameter is identified. The output with the highest probability determines the identification. A class label for each answer may be used to compute a loss (e.g., loss function). he trained configuration MLM 128 then uses a loss function that quantifies the error between the predicted output and the ground truth for a given training sample. In other words, the loss function can be used to guide the learning process by updating the network weights in a way that improves the accuracy of future predictions. This process may continue until the difference between the prediction and the correct targets is minimal. In some examples, an appropriate loss function, such as Mean Squared Error (MSE) for regression tasks or a Cross-Entropy Loss for classification tasks. nce the MLM is trained (e.g., inference), the trained configuration MLM 128 may identify hardware, software, and/or runtime configuration parameters for execution of the software code based on analyzing the document 102 and/or software code 103. uring inference, the trained configuration MLM 128 does not re-evaluate or adjust the layers of the neural network based on the results. Instead, the inference applies knowledge from the trained neural network and uses it to infer a result. Accordingly, when a new unknown dataset (e.g., new presentation) is input through the trained configuration MLM 128, the trained MLM outputs a score identifying hardware, software, and/or runtime configuration parameters for execution of the software code based on predictive accuracy of the MLM. imilarly, during preparation (e.g. training) of the troubleshooting MLM 130, the troubleshooting training dataset will include at least annotated execution logs that capture failures in diverse virtual environments. These execution logs should include records of runtime errors, warnings, and debugging outputs that detail failures such as missing dependencies, incompatible library version, incorrect environment variables, insufficient resources (e.g., memory or GPU availability), or unsupported configurations. Each log entry is also annotated to highlight the root cause of the failure and the associated configuration parameters (e.g., GPU not enabled, or mismatched Python version). In addition, labeled examples of successful and failed executions may also be included in the troubleshooting training database. This type of training data will include details of the environment setup, such as software versions, runtime dependencies, and hardware configurations. For example, the execution logs may indicate the differences in configurations between a successful execution with Python 3.9 and TensorFlow 2.6 and a failed execution with Python 3.6 and TensorFlow 2.3. Another type of troubleshooting training data may include a collection of synthetic or real-world execution logs that illustrate edge cases. For example, this may include errors triggered by insufficient disk space or unexpected interactions between dependencies. Each scenario may be annotated with detailed information about the failing parameter (e.g., memory allocation, dependency conflicts, or runtime environment mismatch). or every input training sample from the configuration training dataset, the prepared troubleshooting MLM 130 may produce a prediction consisting of values representing a probability that an identified configuration parameter for the virtual environment is associated with a failure cause in the execution of the software code. The output with the highest probability determines the predicted configuration parameters associated with the failure. ptionally, during training of the optional comparison MLM 132, the comparison training dataset may include pairs of documents or software codes with labeled similarity scores or classifications. This data should encompass diverse programming languages, code styles, and documentation formats, annotated with metadata such as dependencies, runtime configurations, and hardware requirements. Additionally, the comparison training dataset should include examples of previously analyzed documents or code with their known configurations, allowing the model to learn associations between code features and configuration parameters. Pretraining on a large corpus of unlabeled code and documentation can further enhance the model's ability to understand structural and semantic similarities. n some aspects, an optimizer such as Adam or SGD may be used to train the models in the optional paper analysis MLM 122, the optional software analysis MLM 124, the optional assessment MLM 126, the configuration MLM 128, the troubleshooting MLM 130, and/or the optional comparison MLM 132. In some aspects, the data may be split into training, validation, and test sets. In these aspects, the optional paper analysis MLM 122, the optional software analysis MLM 124, the optional assessment MLM 126, the configuration MLM 128, the troubleshooting MLM 130, and/or the optional comparison MLM 132 are trained on the training dataset and then validated by the validation sets in order to tune hyperparameters. he computing device 104 may execute a UI generation module 136 configured to receive inputs from a user and display, in a UI, the execution log on a UI. This module serves as an interactive bridge between the user and the system 100, allowing users to efficiently access and analyze execution logs in a structured and visually comprehensible manner. By enabling real-time log visualization, it enhances debugging and troubleshooting by providing clear insights into execution events, errors, and configuration parameters. The UI generation module 136 also allows users to filter, search, and navigate logs dynamically, improving efficiency in identifying issues and optimizing software performance. This functionality is particularly valuable in complex software environments where manual log inspection can be time-consuming and error prone. Furthermore, by integrating interactive UI elements, such as charts, highlighting, and categorization, the module improves user experience and accelerates root cause analysis. Overall, the UI generation module 136 plays a crucial role in streamlining execution monitoring, enhancing system transparency, and supporting more effective software maintenance and troubleshooting. t should be noted that the identification of hardware, software, and/or runtime configuration parameters for execution of the software code and the identification of the configuration parameters associated with a cause of failure in execution of the software code is heavily simplified. One of skilled win the art will appreciate that the machine learning models utilized may have significantly large datasets with highly specific details. For example, there may be hundreds of configuration parameters in each execution of the software code. The analysis would be beyond the capabilities of the human mind because the amount of data to be identified and analyzed in each scientific or technical document is unfathomable. FIG. 2s a block diagram illustrating a system for training machine learning models to identify logic, algorithms, and/or parameters of scientific or technical documents and associated software code. s shown in example 200, a MLM training module 134 is configured to build and train specialized machine learning models with inference to perform particular tasks. In this way, the specialized MLMs may develop an ability to perform particular objectives within new data that is not part of a training dataset. By subjecting the specialized MLMs to large amounts of unlabeled and/or labeled trained data sets, the specialized MLMs may perform particular tasks such as identifying hardware, software, and/or runtime configuration parameters for execution of the software code by analyzing the document and/or software code and identifying configuration parameters of the virtual environment associated with a cause of failure in the execution of the software code. upervised learning is effective for tasks such as classification (assigning inputs to predefined categories) and regression (predicting continuous values) since it relies on the availability of labeled data for both training and evaluation phases. In supervised learning, the MLM training module 134 trains the algorithm on a labeled dataset, where each input has a corresponding output. The goal is to learn a mapping function from inputs to outputs, allowing the algorithm to make predictions or classifications on new, unseen data. The process typically involves the following steps: training, model building, prediction, feedback, and adjustment. n the training phase, the MLM training module 134 provides the algorithm with a training dataset 202 including input-output pairs. The algorithm learns the mapping function that relates inputs to outputs through an iterative process, adjusting its internal parameters based on the provided examples. During model building, the algorithm creates a model that can generalize from the training data to make predictions on new, unseen data. The model's complexity varies based on the algorithm used. For example, the model may be a simple linear regression model or a complex neural network. During the prediction phase, the MLM training module 134 inputs test inputs (i.e., inputs with known outputs) into the model, which generates predictions or classifications based on what it has learned during training. The accuracy of predictions is evaluated by comparing them to the known outputs in a validation or test dataset. During the feedback and adjustment phase, machine refines the model based on feedback from its predictions. If the predictions differ from the actual outputs, the algorithm adjusts its internal parameters to minimize the errors. The performance of the trained model is assessed using metrics such as accuracy, precision, recall, etc., depending on the nature of the problem. n some aspects, the MLM training module 134 contains at least a training database 213 configured to store the raw training data 219n and corresponding labels, a machine learning model database 215 to store the trained models (e.g., the optional paper analysis model 227a, the optional software analysis model 227b, the optional assessment model 227c, the configuration MLM 227d, the troubleshoot MLM 227e, and/or the optional comparison MLM 227f). In some aspects, the MLM training module 134 may contain an optional filtering machine learning module 229 and an optional filter module 217 configured to filter data from the training database 213 for training by removing bad training data. raining data 202 from the optional research paper dataset 205, the optional software code dataset 207, configuration dataset 208, troubleshoot dataset 210, and/or the optional comparison dataset 212 is received into the MLM training module 134 via the training set generator 211. n optional filter module 217 is configured to filter out bad training data in order to clean up the training data in the training dataset 219n. In some examples, the optional filter module 217 may be a neural network. In some examples, the optional filter module 217 is a simple mathematical model. In some examples, the cleaned training dataset 221n then undergoes optional preprocessing steps depending on which neural network or model is being trained. he optional preprocess 1 223a, preprocess 2 223b, preprocess 3 223c, preprocess 4 223d, preprocess 5 223e, and/or the preprocess 6 223f are automated processes that modify the raw data received from 219n (or cleaned training dataset 221n) and prepare the raw data as input to the respective model trainers (e.g., an optional paper analysis model trainer 225a, an optional software analysis model trainer 225b, an optional assessment model trainer 225c, a configuration model trainer 225d, a troubleshoot model trainer 225e, and/or an optional comparison model trainer 225f). These may be described in the MLM training module 134 as snippets of code that prepares the datasets. In some examples, the preprocessing module (e.g., preprocess 1 223a, preprocess 2 223b, preprocess 3 223c, preprocess 223d, preprocess 223e, or preprocess 223f) for a particular trainer may be an automated script or code that will be setup the first time any model is trained. he optional paper analysis model trainer 225a, the optional software analysis model trainer 225b, the optional assessment model trainer 225c, the configuration model trainer 225d, the troubleshoot model trainer 225e, and/or the optional comparison model trainer 225f are the scripts or code that train the model. The optional paper analysis model trainer 225a, the optional software analysis model trainer 225b, the optional assessment model trainer 225c, the configuration model trainer 225d, the troubleshoot model trainer 225e, and/or the optional comparison model trainer 225f may be a script or code that holds the instructions on how a model should be trained (e.g., optimization method, model architecture, dataset division, etc.) and also runs the training. The optional paper analysis model trainer 225a, the optional software analysis model trainer 225b, the optional assessment model trainer 225c, the configuration model trainer 225d, the troubleshoot model trainer 225e, and/or the optional comparison model trainer 225f each take as input the raw or filtered processed training data and train the optional paper analysis model 227a, the optional software analysis model 227b, the optional assessment model 227c, the configuration MLM 227d, the troubleshoot MLM 227e, and/or the optional comparison MLM 227f to achieve their specific objectives, respectively. n summary, the raw dataset 219n or cleaned dataset 221n may optionally go through different preprocessing steps 223a, 223b, 223c, 223d, 223e, and 223f and then a corresponding optional paper analysis model trainer 225a, optional software analysis model trainer 225b, optional assessment model trainer 225c, configuration model trainer 225d, troubleshoot model trainer 225e, and/or optional comparison model trainer 225f to generate an optional prepared paper analysis model 227a, an optional prepared software analysis model 227b, an optional prepared assessment model 227c, a prepared configuration MLM 227d, a prepared troubleshoot MLM 227e, and/or an optional prepared comparison MLM 227f. In some examples, each of these models may be an LLM or autoencoder. he LLMs are trained through a multi-step process involving vast amounts of text data and sophisticated machine learning techniques. The training generally occurs in three stages: pre-training, fine-tuning, and scaling. The first step generally includes data collection since LLMs require massive amounts of text data to learn the patterns, structures, and relationships in language. The goal is to expose the model to a wide variety of text forms, genres, and topics to help it generalize well to different contexts. In the pre-training phase, the model is then trained on a large corpus of text in an unsupervised manner, typically using self-supervised learning techniques. The most common training objective is language modeling. The training may be done using a neural network architecture called the transformer, which excels at capturing long-range dependencies in text. Pre-training allows the model to learn grammar, facts about the world, and how language is structured. ey components during the pre-training phase include: a transformer architecture, an attention mechanism, and tokenization. A transformer architecture may be composed of layers of self-attention mechanisms and feed-forward networks, which enable the model to focus on different parts of the input. Next, attention mechanism allows the model to weigh the importance of different words in the context of others, helping it understand relationships in text better than traditional models. Text is then broken into smaller units (e.g., tokens), like words or subwords, to make it easier for the model to process. fter pre-training, the model undergoes fine-tuning to adapt it to more specific tasks, such as question answering, summarization, or chatbot interaction. Fine-tuning uses smaller, task-specific datasets and often involves supervised learning. The model may be exposed to labeled data where inputs (e.g., questions) are paired with expected outputs (e.g., answers) so it can adjust its internal parameters to better perform on that specific task. During training, the model’s predictions are compared to the correct answers, and the differences (errors) are minimized using a loss function like cross-entropy loss. The model’s parameters are updated via optimization algorithms like stochastic gradient descent (SGD) or its variants (e.g., Adam optimizer) to reduce the loss and improve performance. nce the LLMs are set up, LLMs may be scaled by using more data such as pre-training on larger datasets to improve generalization. LLMs also use hundreds of billions of parameters, increasing their capacity to capture complex language relationships. Models may also be trained for millions of iterations on powerful distributed hardware (e.g., GPUs, TPUs) to refine their internal representations. he raw training dataset 219n used for training may contain noise and bad training images from the training database 213. Accordingly, to create a clean and filtered training dataset, the optional filter module 217 is configured to filter out unwanted data points from the raw training dataset 219n by developing smaller, less accurate systems based on patterns and metadata information. For example, an automated system may be created to identify hardware, software, and/or runtime configuration parameters for execution of a software code using a prepared configuration MLM 227d to analyze different scientific or technical documents and/or software code. The resulting training dataset 221n may consist of scientific or technical documents and labels, where each scientific or technical document contains labeled configuration parameters. hen a new model (e.g., an optional prepared paper analysis model 227a, an optional prepared software analysis model 227b, an optional prepared assessment model 227c, a configuration MLM 227d, a troubleshoot MLM 227e, and/or an optional prepared comparison MLM 227f) is created, and a new process for filtering and automated labeling is established, it is added to the machine learning model database 215 in the MLM training module 134. This enables the new model to be part of the closed-loop model update process. Optionally, at regular intervals, data which is continuously collected can be filtered, labeled, and used to update old models by an optional filtering machine learning module 229. In some examples, the optional filtering machine learning module 229 is a neural network. In some examples, the optional filtering machine learning module 229 is a simple mathematical model. FIG. 3s a flow diagram of a method for finding correspondence between parameters according to aspects of the present disclosure. In various implementation, the method 300 is performed by a device with one or more processors and non-transitory memory that performs intent prediction. In some implementations, the method 300 is performed by processing logic, including hardware, firmware, software, or a combination thereof. In some implementations, the method 300 is performed by a processor executing code stored in a non-transitory computer-readable medium (e.g., a memory). ptionally, at 302, the method 300 includes extracting an algorithm (or logic) from a scientific or technical document. Optionally, at 304, the method 300 includes marking parameters related to specific steps of the algorithm. In some aspects, the method 300 includes identifying scientific features such as names of algorithms and parameters from the scientific or technical document and obtaining descriptions of the algorithms and parameters from external sources. In some aspects, the method 300 may include marking parameters from the scientific or technical document, citations in the scientific or technical document, and diagrams in the scientific or technical document. t 306, the method 300 includes extracting algorithm from software code associated with the scientific or technical document. At 308, the method 300 includes marking parameters related to specific steps of the algorithm. t 310, the method 300 includes combining the algorithms into a prompt for a LLM. In some aspects, this step may include using the LLM to find correspondence between parameters in the scientific or technical document and in the corresponding software code. t 312, the method 300 includes determining a correspondence between parameters of the scientific or technical document and the software code. This step is necessary because the scientific or technical document may use one set of parameters and values and the software code may use a different set of parameters and values. In this way, the logic of the code may be understood such that each parameter in the scientific or technical document has a mapping to a parameter in the software code. n some aspects, context may be uploaded for finding correspondence between parameters by a human or via a LLM. t 314, the method 300 includes generating text explaining results of the correspondence. In this way, a user may understand the logic of the article and code and understand what each parameter means. FIG. 4s a flow diagram of a method for machine learning (ML)-assisted analysis of scientific or technical documents and associated software code according to aspects of the present disclosure. In various implementation, the method 400 is performed by a device with one or more processors and non-transitory memory that performs intent prediction. In some implementations, the method 400 is performed by processing logic, including hardware, firmware, software, or a combination thereof. In some implementations, the method 400 is performed by a processor executing code stored in a non-transitory computer-readable medium (e.g., a memory). The method 400 includes at least analyzing a scientific or technical document and software code associated with the scientific or technical document to create a correspondence between subject matter, logic, algorithms, and/or parameters in the text of the scientific or technical document and parameters in the software code for analysis and/or reconfiguration. ne of the key principles of scientific research is verification and reproducibility, meaning that other researchers should be able to replicate the results described in the scientific or technical document. By providing an accompanying computer code, researchers provide transparency and enable others to verify their findings or build on their work. This is especially important in field like computational sciences, machine learning, and bioinformatics. t 402, the method 400 may include retrieving a scientific or technical document and a software code associated with the scientific or technical document. The software code may include executable code and/or source code. In some aspects, the method 400 may include retrieving a link to the software code and run the software code in a dedicated, secure computing environment for analyzing logic and/or parameters of the software code. As an example, referring back to FIG. 1, a retrieval module 114 may be configured to retrieve a scientific or technical document and a software code associated with the scientific or technical document. n some aspects, the method 400 may include extracting parameters (e.g., dynamic parameters, Courant, Reynolds numbers, etc.) from the scientific or technical document, citations in the scientific or technical document, diagrams in the scientific or technical document, and links to the code repository. t 404, the method 400 may include identifying scientific features including at least one of subject matter, logic, algorithms, and/or parameters represented in the scientific or technical document by analyzing the scientific or technical document by analyzing the scientific or technical document for the scientific features. In some aspects, the scientific features comprise at least data structures, functions and variable of the functions. ptionally, method 400 may include analyzing the scientific or technical document using a trained paper analysis MLM configured to identify the scientific features represented in the scientific or technical document. In some aspects, the scientific features may include logic, algorithms, and/or parameters of the scientific or technical document that comprise at least data sets, equations and parameters of the equations. As an example, referring back to FIG. 1, a prepared paper analysis MLM 122 may be configured to identify scientific features including at least one of subject matter, algorithms, parameters, and/or logic of the scientific or technical document 102 using a text interpretation LLM. n some aspects, the method 400 may include preparing the paper analysis MLM based on a text interpretation large language model to identify different subject matter, logic, algorithms, and/or parameters using one or more other scientific or technical documents from a research paper database. This may involve leveraging techniques from natural language processing (NLP), program analysis, and machine learning. Once the paper analysis MLM is sufficiently trained and validated, the paper analysis MLM may be deployed as a service (API) or integrated into a larger code analysis tool or development environment. n some aspects, the method 400 may include preparing the software analysis MLM to identify different subjects, parameters, and/or logic using one or more software code from a code database. n some aspects, identifying the corresponding scientific features represented in the analyzed software code is based at least in part on searching for scientific features in the software code using the trained software analysis MLM. n some aspects, searching for the scientific features in the software code further comprises: obtaining partial algorithms in the scientific or technical document and the software code; identifying scientific features in the partial algorithms in the software code that are similar to the identified scientific features of the partial algorithms in the scientific or technical document; juxtaposing the scientific features found in the partial algorithms in the scientific or technical document and in the partial algorithms in the software code; and determining similarities between the scientific features found in the partial algorithms in the scientific or technical document and partial algorithms in the software code. n some aspects, searching for scientific features in the software code further comprises: benchmarking the results of the search and displaying a level of confidence corresponding to a similarity of each identified methodology feature represented in the software code with the identified methodology feature represented in the scientific or technical document. ptionally, in some aspects, the method 400 may include identifying corresponding parameters in the scientific or technical document and the software code by juxtaposing the scientific features of the scientific or technical document with the features of algorithms and parameters of the associated software code; and displaying, in the user interface, at least the identified corresponding parameters in the scientific or technical document and the software code. t 406, the method 400 may include obtaining a description of the identified scientific features from external sources. In some aspects, the method 400 may include displaying the description of the scientific features to the user for confirmation. ptionally, the method 400 may include analyzing portions of the software code using a trained software analysis MLM configured to identify scientific features from the scientific or technical document in the software code using a trained software analysis MLM configured to identify the corresponding scientific features represented in the analyzed software code based on the obtained description of the identified scientific features represented in the scientific or technical document. The portions of the software code being identified based on external sources. As an example, referring back to FIG. 1, an optional prepared software analysis MLM 124 may be configured to analyze software code associated with the scientific or technical document to also identify subject matter, algorithms, parameters, and/or logic of the software code using software code from a software library database 150. s an example, if a methodology feature such as Reynolds number is identified in the article and then a comment in the corresponding software code indicating a “Reynolds number” alongside a variable named “RNDN”, then the optional software analysis MLM 124 can infer that the RNDN variable pertains to the Reynolds number. Alternatively, if a variable itself is named “ReynoldN”, then the optional software analysis MLM 124 may correctly predict that the variable “ReynoldN” relates to the Reynolds number. n some aspects, the method 400 may include training the software analysis MLM to identify different subject matter, logic, algorithms, and/or parameters using one or more software code from a code database. To analyze software code using the optional prepared software analysis MLM 124, the software code may be preprocessed, run inference with the trained software analysis MLM, and interpret the output including at least identification of subject matter, logic patterns, specific algorithms and/or parameters used in the software code. By interpreting and visualizing the trained software analysis MLM’s output, the method 400 may generate detailed insights into the code structure and functionality. n some aspects, analyzing the software code may include: generating a secure virtual environment configured to execute software code; and executing the software code in the secure virtual environment. In some aspects, the security virtual environment may include one of a virtual machine, a container, or a sandbox. As an example, referring back to FIG. 1, a virtual environment generation module 108 may be configured to generate and execute a suitable and secure computing environment configured to execute software code (e.g., C++, Python, MATLAB, etc.) attached to a scientific or technical document. enerating and executing software code in a secure virtual environment offers a wide range of benefits, including improved security, isolation, and reproducibility, as well as efficient resource management. These environments help protect the host system from potential risks, streamline dependency management, facilitate testing and debugging, and enhance portability across platforms. For developers, testers, and system administrators, virtual environments provide a safe and consistent way to execute code, ensuring that software runs reliably in various configurations while minimizing risk to the host system. n some aspects, executing the software code may include: retrieving and utilizing one or more software libraries for the execution of the software code. The software libraries help execute, manage, and even secure code, offering environments for testing, development, deployment, or scripting. These software libraries and frameworks provide various methods for executing code across multiple domains, whether for testing, development, high-performance computing, or large-scale data processing. The appropriate tool may be selected depending on requirements (e.g., secure execution, distributed processing, or containerized environments) to ensure efficient and secure code execution. n some aspects, executing the software code may include: checking the software code for malware and/or security vulnerabilities; and based on a determination that the software code contains malware and/or serious security vulnerabilities, terminating execution of the software code. As an example, referring back to FIG. 1, an optional malware module 110 may be configured to check the software code for malware and/or security vulnerabilities, and, based on a determination that the software code contains malware and/or security vulnerabilities, the optional malware module 110 may be configured to terminate execution of the software code to protect the system from the malware code. n some aspects, the method 400 may further include uploading context for configuring the secure virtual environment and/or finding correspondence between parameters by an agent (e.g., human or LLM). This may include at least: finding the project on a code repository (e.g., GitHub), recognizing the programming language of the project, defining parameters for the code, environment, and requirements, recognizing the programming language of the project, searching for descriptions of libraries, gathering additional information from similar projects, handling voice input to check the sufficiency of requirements and parameters; and using the LLM to ask users additional questions about other requirements and parameters. n some aspects, a LLM may be used to generate a script for creating a computational/virtual environment (VM) based on the combined requirements and context with suitable parameters of the instance (e.g., GPU, CPU, ARM, memory, disk, versions, or other requirements). The computational/VM is a software environment that allows users to run and test code or simulations in an isolated, controlled space, separate from the main system environment. This isolation helps in managing dependencies, libraries, and settings specific to a project or task without affecting or conflicting with other environments on the system. Next, an instance (e.g., container) may be generated for processing the code based on the parameters. Containers are lightweight environments that package code, libraries, and dependencies together. t 408, the method 400 may include juxtaposing subject matter, logic, algorithms, and/or parameters of the scientific or technical document with the subject matter, logic, algorithms, and/or parameters of the associated software code to identifying corresponding subject matter, logic, algorithms, and/or parameters in the scientific or technical document and the software code. As an example, referring back to FIG. 1, the optional comparison module 116 may be configured to identify corresponding algorithms and parameters in the scientific or technical document and the software code by comparing subject matter, logic, algorithms, and/or parameters of the scientific or technical document with the subject matter, logic, algorithms, and/or parameters of the associated software code in order to identify corresponding subject matter, logic, algorithms, and/or parameters between the scientific or technical document and the software code. n some aspects, identifying the correspondence between the software code and the scientific or technical document further comprising: preparing and executing an assessment MLM to perform the assessment of whether the software code corresponds to the scientific or technical document, based on a training dataset comprising scientific or technical documents and corresponding software code, and to generate text explaining the results of the comparison using a text generation LLM. As an example, referring back to FIG. 1, an optional trained assessment MLM 126 may be configured to perform the assessment of whether the software code corresponds to the scientific or technical document 102 and generates text explaining the results of the comparison using a text generation LLM. n some aspects, assessing whether the software code corresponds to the scientific or technical document further comprises: extracting scientific features from the scientific or technical documents and corresponding software code; marking parameters from the scientific or technical documents related to specific steps of the extracted features; combining the algorithms from the scientific or technical documents and the algorithms from the corresponding software code into prompts for the trained assessment MLM; and determining correspondences between the extracted parameters and corresponding values from text of the scientific or technical documents and parameters and corresponding values from the corresponding software code using the trained assessment MLM. t 410, the method 400 may include displaying, in a user interface, at least the corresponding scientific features from the scientific or technical document and the software code. In this way, a user may confirm or correct the identified parameters between the scientific or technical document and the software code. As an example, referring back to FIG. 1, UI generation module 136 configured to receive inputs from a user and display, in a UI, corresponding algorithms and parameters in the scientific or technical document and the software code. n some aspects, the method 400 may include displaying, in the user interface, parameters in the software code using a visual indicator configured to accept, deny, or edit correspondence. This allows a user to easily view and find where particular parameters are presented in the software code. n some aspects, the method 400 may further include: obtaining a modification of at least one parameter in the software code; and executing the software code with the modified at least one parameter. In this way, a user may find and correct an incorrect parameter in the software code and re-execute the computer code with the modified parameter. A user may modify a parameter by using language commands, configuration files, or any suitable means. n some aspects, the method 400 may include allowing a user to change parameters in the software code. As an example, the user may modify the variables and observe the impact on the calculation results. As another example, a Reynolds number may be found in the software code and the user can change the value of the Reynolds number within the UI to re-execute the code with a different parameter. A user may want to change the Reynolds number in the software code and re-execute the code for a variety of reasons, particularly related to exploring fluid dynamics, validating results, or studying new scenarios. As an example, the user may want to explore fluid behavior at different flow regimes and since the Reynolds number is a critical parameter in determining whether the flow is laminar, turbulent, or in transition - changing it allows the user to study how fluid behavior evolves across these regimes. Users might want to investigate Reynolds numbers beyond those analyzed in the paper to explore new flow conditions or phenomena. As another example, the user may want to determine the impact of the Reynolds number such that by changing the Reynolds number, the user can study how sensitive a system’s behavior (e.g., drag, heat transfer, or mixing) is to changes in flow characteristics. As yet another example, a user may want to validate computational or theorical results against experimental data that involves different Reynolds numbers. Users may also need to reproduce the findings of a scientific paper by running simulations at the same or similar Reynolds numbers used in the study. FIG. 5 s a low diagram of a method 500 for executing software code associated with scientific or technical documents in a virtual environment according to aspects of the present disclosure. In various implementation, the method 500 is performed by a device with one or more processors and non-transitory memory that performs intent prediction. In some implementations, the method 500 is performed by processing logic, including hardware, firmware, software, or a combination thereof. In some implementations, the method 500 is performed by a processor executing code stored in a non-transitory computer-readable medium (e.g., a memory). The method 500 includes at least analyzing a scientific or technical document 102 and software code 103 associated with the document 102 to identify hardware, software, and/or runtime configuration parameters for execution of the software code. s shown in FIG. 5, the method 500 begins utilizing a prepared configuration MLM 227d (e.g., configuration MLM 128 shown in FIG. 1) to analyze a technical or scientific document 102 and/or software code 103 associated with the document for identifying parameters 510 for the virtual environment 170 including at least hardware configuration parameters 504b, software configuration parameters 504a, and/or runtime configuration parameters 504c for execution of the software code 103 (e.g., collectively, the basic configuration 504). The purpose of the prepared configuration MLM 227d is to identify key execution configuration parameters for execution of the software code in the virtual environment 170. As explained in FIGS. 1-2, the prepared configuration MLM 227d has been prepared (e.g., pre-trained) to recognize patterns within technical documents and source code that indicate essential execution requirements. By analyzing the document 102 and/or the software code 103, the prepared configuration MLM 227d extracts information related to hardware specifications, software dependencies, and runtime configurations, which may also include references to operating systems, required libraries, or specific computational constraints. In addition, the software code 103 is analyzed to detect embedded configuration parameters such as function calls, external dependencies, and environmental variables that may define execution conditions. The prepared configuration MLM 227d then correlates findings from both the documents 102 and/or the software code 103 to determine precise execution requirements, including necessary hardware components (e.g., hardware configuration parameters 504b) like processors or GPUs, software dependencies (e.g., software configuration parameters 504a) such as compilers and frameworks, and runtime settings (e.g., runtime configuration parameters 504c) like execution flags or input parameters. asic configurations 504 generally refer to a set of predefined parameters (e.g., at least software configuration parameters 504a, hardware configuration parameters 504b, and/or runtime configuration parameters 504c determined for a particular code) that control the behavior, operation, and performance of the virtual environment 170. oftware configuration parameters 504a define how the virtualized software environment is set up and executed. As a non-limiting example, the software configuration parameters 504a may include at least operating system settings (e.g., Linux kernel version, Windows registry policies), virtual machines (VM) or Container configurations (e.g., Docker Compose YAML, Kubernetes pod specifications), software dependency management (e.g., Python Virtualenv, Conda environments, package versions), networking and security settings (e.g., firewall rules, SSH access, VPN settings), Filesystem and storage mappings (e.g., mounted volumes, cloud storage integration), middleware and application configurations (e.g., web sever settings, API gateways, database connections), languages, packages, links, version control settings (e.g., dependencies, library versions), and the like. ardware configuration parameters 504b dictate how the physical resources are allocated and managed in the virtual environment. As a non-limiting example, the hardware configuration parameters 504b may include at least CPU allocation (e.g., number of virtual CPUs assigned, CPU pinning for performance tuning), memory allocation (e.g., RAM limit per VM/container, swap memory usage), storage management (e.g., SSD v. HHD allocation, disk quotas, persistent volume claims in Kubernetes), GPU settings (e.g., GPU pass-through for AI/ML workloads, CUDA-enabled configurations), network configurations (e.g., virtual NIC settings, VLAN configurations, NAT vs. bridged mode), Power Management Policies (e.g., dynamic scaling, auto-shutdown of idle instances), CPU/GPU specifications, memory (e.g., type, size), storage (PVC, type, size), or the like. untime configuration parameters 504c influence system behavior during execution. As a non-limiting example, the runtime configuration parameters 504c may include at least one of environmental variables (e.g., PYTHONPATH, JAVA_HOME, LD_LIBRARY_PATH), resource constraints (e.g., CPU and memory limits for containers using cgroups), performance tuning (e.g., garbage collection settings, thread pool sizes), dynamic scaling (e.g., Kubernetes Horizonal Pod Autoscaling (HPA), autos-scaling in cloud environments), session management (e.g., timeout settings, stateful vs. stateless execution), logging and monitoring (e.g., logging levels, distributed tracing with Prometheus, Fleuntd, or ELK stack), time executing or permanent executing (e.g., outer servers), a number of exemplars in executing, method of executing (e.g., Terraform, Kubernetes cluster, AVS entities, Docker compose, installation on operation systems), or services (e.g., databases). he basic configurations 504 for the virtual environment 170 may be stored in the software library database 150 to facilitate efficient provisioning, management, and reuse of configurations for different applications or workloads. By maintaining these parameters in a structured repository, the system ensures consistency across deployments, enabling automated setup of virtual machines and containers without requiring manual reconfiguration. Storing these parameters also allows for version control, ensuring that previous configurations can be referenced, modified, or rolled back if needed. Additionally, the software library database 150 acts as a centralized knowledge base, making it easier to standardize deployments across different environments, troubleshoot, enhance security compliance, and optimize resource allocation based on predefined settings. This approach improves operational efficiency by allowing rapid scaling, seamless updates, and better troubleshooting when deploying software in virtualized or containerized environments. n some aspects, the basic configurations 504 and/or the identified parameters 510 including at least hardware configuration parameters 504b, software configuration parameters 504a, and/or runtime configuration parameters 504c for execution of the software code 103 may be displayed to a user through a UI 508, 514 or other suitable display mechanism. This presentation allows the user to review and optionally modify any of the displayed basic configurations 504 or displayed parameters 510 of the virtual environment before commencing execution of the software code 103 in the virtual environment 170. By providing users with the opportunity to manually configure or fine-tune these parameters, the system ensures that the chosen hardware, software, and runtime settings align with the specific requirements or preferences for the given execution, thereby enhancing the flexibility and adaptability of the overall environment. arameters 510 for the virtual environment are actual configuration settings for the virtual execution environment determined based on basic configuration parameters 504. The identified parameters 510 for the virtual environment encompass the configuration details and settings required to define how a piece of software or an application will run in a virtual or containerized space. In some aspects, the virtual environment may correspond to a virtual machine and container (e.g., Terraform). These identified parameters 510 may include hardware specifications (e.g., CPU cores, memory allocation, GPU access), software components (e.g., operating system version, application dependencies, libraries), networking configurations (e.g., ports, load balancers, DNS settings), storage requirements (e.g., volumes, file system types), security policies (e.g., access controls, encryption settings), and/or runtime configurations (e.g., environment variables, startup scripts, scaling rules). By identifying and organizing these parameters, the system can accurately provision and manage virtual environments that are tailored to the needs of each application or workload. s a non-limiting example, the identified parameters 510 of the virtual environment may include at least one of: selecting whether to executed code in a virtual machine (VM) or container, select which type/manufacturer VM or container is better (e.g. Docker), select which cloud provider to use (e.g. MS Azure, Google Cloud or AWS), select virtual CPU/memory/storage requirements for code execution, select Kubernetes or Terraform, or selecting security configuration for the virtual environment (e.g., SSH config). Accordingly, the identified parameters 510 of the virtual environment 170 may be used to create, configure, and deploy resources on a cloud platform 512, such as through Terraform or Kubernetes. For example, by translating these identified parameters into infrastructure-as-code definitions, Terraform can dynamically provision and manage the underlying compute, storage, and networking resources. As another example, Kubernetes may orchestrate and scale containerized applications in accordance with the parameters defined for the virtual environment 170. n some aspects, prior to analyzing the document 102 and/or software code 103 using the prepared configuration MLM 227d, an optional prepared comparison MLM 227f (e.g., configuration MLM 128 from FIG. 1) may access an analyzed documents and software database 154 containing previously analyzed documents and associated software codes with known hardware, software, and/or runtime configuration parameters to identify a similar document and/or software code in the database and the associated known configuration parameters. In this way, the system may leverage already analyzed documents and associated software codes to pre-configure the virtual environment 170 with default parameter value 506, streamlining setup and reducing the need for manual configuration. This approach enhances efficiency by reusing previously established configurations for similar documents. n the execution stage, once the virtual environment 170 is provisioned with the identified parameters 510, the software code 103 is executed 516 within this configured virtual environment 170. This execution process ensures that the code operates with the appropriate hardware resources, software dependencies, and runtime settings, reducing variability and improving reproducibility across different deployments. As the software runs, an execution log 518 is generated to capture critical details such as system resource usage, runtime events, error messages, and performance metrics. This execution log 518 provides valuable insights into the execution process, aiding in debugging, performance optimization, and compliance tracking. By maintaining a structured execution log 518, the system enables better monitoring, troubleshooting, and auditing of software performance in both development and production environments. n some aspects, the software code 103 may be executed in a “sandbox” mode. he execution log 518 can be utilized by docket-containers in conjunction with Ansible, particularly when deploying virtual machines via Terraform. Additionally, the system supports direct deployment of Docker containers using Kubernetes through HELM (E.g., a package manager for Kubernetes that simplifies the deployment and management of applications within Kubernetes clusters). This functionality ensures streamlined automation and orchestration of the virtual environment 170, enhancing deployment efficiency and consistency across different containerized infrastructures. t 520, the method 500 determines whether code execution is successful. Based on a determination that code execution is successful, then the method 500 ends 522. Based on a determination that the execution is not successful 520, the method 500 continues to a troubleshooting stage. prepared troubleshooting MLM 227e (e.g., troubleshooting MLM 130 from FIG. 1) may be prepared to analyze at least the execution log 518 to identify configuration parameters of the virtual environment that may be linked to execution failure. As described in detail in FIGS. 1-2, the prepared troubleshooting MLM 227e is trained on historical execution data from the software library database 150, error patterns, and system behavior to detect anomalies or misconfigurations that could have contributed to the failure. By examining factors such as resource allocation mismatches, dependency conflicts, runtime errors, or performance bottlenecks, the prepared troubleshooting MLM 227e can pinpoint potential root causes efficiently. This automated analysis helps reduce manual debugging efforts, accelerates issue resolution, and improves system reliability by suggesting corrective actions, such as adjusting hardware resources, updating dependencies, or modifying runtime configurations to prevent future failures. o enhance troubleshooting, the prepared troubleshooting MLM 227e can search internal databases 524 or the software library database 150 for past failures, compare execution logs to known issues, and suggest proven fixes. Additionally, prepared troubleshooting MLM 227e can query online sources, such as technical forums, documentation, and cloud provider recommendations, to identify potential solutions and best practices. t 526, a determination is made based on the results of the prepared troubleshooting MLM 227e as to whether the software code may be fixed by modifying parameters for the virtual environment. Based on a determination that the code cannot be executed successfully in the virtual environment 170 (e.g., cannot be fixed), the method 500 ends 522. Based on a determination that parameters of the virtual environment may be modified to fix execution (e.g., can be fixed) according to results of the troubleshooting, the method 500 continues to a modification stage. n the modification stage, the parameters of the virtual environment may be modified 528 according to results from the troubleshooting and the software code 103 is re-executed 516 within the virtual environment 170 provisioned with the modified identified parameters 510. The method 500 then re-continues to the execution stage and troubleshooting stage. FIG. 6s an example of a method for executing software code associated with scientific or technical documents in a virtual environment according to aspects of the present disclosure. In various implementation, the method 600 is performed by a device with one or more processors and non-transitory memory that performs intent prediction. In some implementations, the method 600 is performed by processing logic, including hardware, firmware, software, or a combination thereof. In some implementations, the method 600 is performed by a processor executing code stored in a non-transitory computer-readable medium (e.g., a memory). The method 600 includes at executing software code associated with scientific or technical documents in a virtual environment. t 602, the method 600 may include receiving a scientific or technical document and software code associated with the document. The software code may include executable code and/or source code. t 604, the method 600 may include analyzing the document and/or software code using a first prepared MLM (e.g., the configuration MLM 128 in FIG. 1, and the prepared configuration MLM 227d in FIGS. 2 and 5) to identify hardware, software and/or runtime configuration parameters for execution of the software code. n some aspects, the first prepared MLM corresponds to a large language model (LLM). ptionally, in some aspects, the method 600 may include: prior to analyzing the document and/or software code using the first prepared MLM, accessing a database containing a plurality of previously analyzed documents and associated software codes with known hardware, software and/or runtime configuration parameters (e.g., analyzed documents and software database 154 shown in FIGS. 1 and 5); comparing, using a third prepared MLM (e.g., comparison MLM 132 from FIG. 1 or the optional prepared comparison MLM 227f from FIGS. 2 and 5), the document and/or software code with the previously analyzed documents and/or software codes to identify a similar document and/or software code in the database and the associated known configuration parameters; and configuring the virtual environment based at least in part on one or more of the known configuration parameters of the similar software code from the database. n some aspects, the third MLM corresponds to an autoencoder or a transformer-based models. An autoencoder is a type of neural network used for unsupervised learning, primarily for feature extraction and dimensionality reduction. It consists of an encoder, which compresses input data into a lower-dimensional representation (latent space), and a decoder, which reconstructs the original input from this representation. This framework is utilized for extracting feature embeddings from complex datasets. Conversely, transformer-based models, leverage self-attention mechanisms to process input data, capturing complex dependencies and contextual information without the need for compression into a latent space. These models, therefore, generate contextual embeddings that encapsulate both local and global relationships within the data. To implement the third prepared MLM for comparing documents and software code, one could utilize either an autoencoder or a transformer-based approach. These models can be trained on datasets containing previously analyzed documents and software codes to derive meaningful feature embeddings. As new documents or code are introduced, the system extracts feature embeddings using the trained model and compares them with stored in a database. By measuring similarity (e.g., using cosine similarity or Euclidean distance) between the embeddings, the system can identify documents or code with similar structures and retrieve their associated known configuration parameters. This enables automated configuration recommendation based on past analyzed data. t 606, the method 600 may include configuring the virtual environment based at least on one or more identified configuration parameters. n some aspects, the virtual environment comprises an isolated, secure virtual environment (e.g., the virtual environment 170 shown in FIGS. 1 and 5) that operates as either a container or a virtual machine. A container, such as those managed by Docker or Kubernetes, shares the host OS kernel while encapsulating applications and dependencies, providing lightweight, efficient isolation. In contrast, a VM, like those powered by VMware or Hyper-V, includes a full OS stack, offering stronger isolation but with higher resource overhead. This isolation ensures security by preventing interference between applications, enhances portability by enabling deployment across different systems, and improves scalability by efficiently managing resources in cloud and on-premise environments. n some aspects, configuring the virtual environment based at least on the identified hardware, software and/or runtime configuration, comprises: identifying and loading into the virtual environment one or more software libraries necessary for execution of the software code. t 608, the method 600 may include executing the software code in the virtual environment and collecting an execution log of the software code. n some aspects, executing the software code comprises checking the software code for malware and/or security vulnerabilities; and based on a determination that the software code contains malware and/or serious security vulnerabilities, terminating execution of the software code. Executing the software code involves an initial security check to detect malware and vulnerabilities before execution. This process uses static and dynamic analysis tools, such as antivirus scanners, signature-based detection, and AI-powered behavioral analysis, to identify malicious code or critical security flaws. If malware or serious vulnerabilities are detected, execution is immediately terminated to prevent system compromise, data breaches, or unauthorized access. t 610, the method 600 may include determining whether the code executes correctly. ased on determination that the code does not execute correction, at 612, the method 600 may include analyzing the execution log using a second prepared MLM (e.g., troubleshooting MLM 130 from FIG. 1 or prepared troubleshooting MLM 227e from FIGS. 2 and 5) to identify configuration parameters of the virtual environment associated with a cause of failure in execution of the software code. n some aspects, the second prepared MLM corresponds to LLM. ased on determination that the code executes correctly, optionally, at 616, the method 600 may include displaying the execution log on a UI. t 614, the method 600 may include modifying the identified configuration parameters of the virtual environment and executing the software code in the modified virtual environment. t 616, the method 600 may include displaying the execution log on a user interface (UI). FIG. 7s a block diagram illustrating a computer system 20 on which aspects of systems and methods machine learning (ML)-based analysis of executing software code associated with scientific or technical documents in a virtual environment may be implemented. The computer system 20 can be in the form of multiple computing devices, or in the form of a single computing device, for example, a desktop computer, a notebook computer, a laptop computer, a mobile computing device, a smart phone, a tablet computer, a server, a mainframe, an embedded device, and other forms of computing devices. s shown, the computer system 20 includes a central processing unit (CPU) 21, a system memory 22, and a system bus 23 connecting the various system components, including the memory associated with the central processing unit 21. The system bus 23 may comprise a bus memory or bus memory controller, a peripheral bus, and a local bus that is able to interact with any other bus architecture. Examples of the buses may include PCI, ISA, PCI-Express, HyperTransport™, InfiniBand™, Serial ATA, I2, and other suitable interconnects. The central processing unit 21 (also referred to as a processor) can include a single or multiple sets of processors having single or multiple cores. The processor 21 may execute one or more computer-executable code implementing the techniques of the present disclosure. For example, any of commands/steps discussed in FIGS. 1-5 may be performed by processor 21. The system memory 22 may be any memory for storing data used herein and/or computer programs that are executable by the processor 21. The system memory 22 may include volatile memory such as a random access memory (RAM) 25 and non-volatile memory such as a read only memory (ROM) 24, flash memory, etc., or any combination thereof. The basic input/output system (BIOS) 26 may store the basic procedures for transfer of information between elements of the computer system 20, such as those at the time of loading the operating system with the use of the ROM 24. he computer system 20 may include one or more storage devices such as one or more removable storage devices 27, one or more non-removable storage devices 28, or a combination thereof. The one or more removable storage devices 27 and non-removable storage devices 28 are connected to the system bus 23 via a storage interface 32. In an aspect, the storage devices and the corresponding computer-readable storage media are power-independent modules for the storage of computer instructions, data structures, program modules, and other data of the computer system 20. The system memory 22, removable storage devices 27, and non-removable storage devices 28 may use a variety of computer-readable storage media. Examples of computer-readable storage media include machine memory such as cache, SRAM, DRAM, zero capacitor RAM, twin transistor RAM, eDRAM, EDO RAM, DDR RAM, EEPROM, NRAM, RRAM, SONOS, PRAM; flash memory or other memory technology such as in solid state drives (SSDs) or flash drives; magnetic cassettes, magnetic tape, and magnetic disk storage such as in hard disk drives or floppy disks; optical storage such as in compact disks (CD-ROM) or digital versatile disks (DVDs); and any other medium which may be used to store the desired data and which can be accessed by the computer system 20. he system memory 22, removable storage devices 27, and non-removable storage devices 28 of the computer system 20 may be used to store an operating system 35, additional program applications 37, other program modules 38, and program data 39. The computer system 20 may include a peripheral interface 46 for communicating data from input devices 40, such as a keyboard, mouse, stylus, game controller, voice input device, touch input device, or other peripheral devices, such as a printer or scanner via one or more I/O ports, such as a serial port, a parallel port, a universal serial bus (USB), or other peripheral interface. A display device 47 such as one or more monitors, projectors, or integrated display, may also be connected to the system bus 23 across an output interface 48, such as a video adapter. In addition to the display devices 47, the computer system 20 may be equipped with other peripheral output devices (not shown), such as loudspeakers and other audiovisual devices. he computer system 20 may operate in a network environment, using a network connection to one or more remote computers 49. The remote computer (or computers) 49 may be local computer workstations or servers comprising most or all of the aforementioned elements in describing the nature of a computer system 20. Other devices may also be present in the computer network, such as, but not limited to, routers, network stations, peer devices or other network nodes. The computer system 20 may include one or more network interfaces 51 or network adapters for communicating with the remote computers 49 via one or more networks such as a local-area computer network (LAN) 50, a wide-area computer network (WAN), an intranet, and the Internet. Examples of the network interface 51 may include an Ethernet interface, a Frame Relay interface, SONET interface, and wireless interfaces. spects of the present disclosure may be a system, a method, and/or a computer program product. The computer program product may include a computer readable storage medium (or media) having computer readable program instructions thereon for causing a processor to carry out aspects of the present disclosure. he computer readable storage medium can be a tangible device that can retain and store program code in the form of instructions or data structures that can be accessed by a processor of a computing device, such as the computing system 20. The computer readable storage medium may be an electronic storage device, a magnetic storage device, an optical storage device, an electromagnetic storage device, a semiconductor storage device, or any suitable combination thereof. By way of example, such computer-readable storage medium can comprise a random access memory (RAM), a read-only memory (ROM), EEPROM, a portable compact disc read-only memory (CD-ROM), a digital versatile disk (DVD), flash memory, a hard disk, a portable computer diskette, a memory stick, a floppy disk, or even a mechanically encoded device such as punch-cards or raised structures in a groove having instructions recorded thereon. As used herein, a computer readable storage medium is not to be construed as being transitory signals per se, such as radio waves or other freely propagating electromagnetic waves, electromagnetic waves propagating through a waveguide or transmission media, or electrical signals transmitted through a wire. omputer readable program instructions described herein can be downloaded to respective computing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network interface in each computing device receives computer readable program instructions from the network and forwards the computer readable program instructions for storage in a computer readable storage medium within the respective computing device. omputer readable program instructions for carrying out operations of the present disclosure may be assembly instructions, instruction-set-architecture (ISA) instructions, machine instructions, machine dependent instructions, microcode, firmware instructions, state-setting data, or either source code or object code written in any combination of one or more programming languages, including an object oriented programming language, and conventional procedural programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a LAN or WAN, or the connection may be made to an external computer (for example, through the Internet). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure. n various aspects, the systems and methods described in the present disclosure can be addressed in terms of modules. The term "module" as used herein refers to a real-world device, component, or arrangement of components implemented using hardware, such as by an application specific integrated circuit (ASIC) or FPGA, for example, or as a combination of hardware and software, such as by a microprocessor system and a set of instructions to implement the module’s functionality, which (while being executed) transform the microprocessor system into a special-purpose device. A module may also be implemented as a combination of the two, with certain functions facilitated by hardware alone, and other functions facilitated by a combination of hardware and software. In certain implementations, at least a portion, and in some cases, all, of a module may be executed on the processor of a computer system. Accordingly, each module may be realized in a variety of suitable configurations, and should not be limited to any particular implementation exemplified herein. n the interest of clarity, not all of the routine features of the aspects are disclosed herein. It would be appreciated that in the development of any actual implementation of the present disclosure, numerous implementation-specific decisions must be made in order to achieve the developer’s specific goals, and these specific goals will vary for different implementations and different developers. It is understood that such a development effort might be complex and time-consuming, but would nevertheless be a routine undertaking of engineering for those of ordinary skill in the art, having the benefit of this disclosure. urthermore, it is to be understood that the phraseology or terminology used herein is for the purpose of description and not of restriction, such that the terminology or phraseology of the present specification is to be interpreted by the skilled in the art in light of the teachings and guidance presented herein, in combination with the knowledge of those skilled in the relevant art(s). Moreover, it is not intended for any term in the specification or claims to be ascribed an uncommon or special meaning unless explicitly set forth as such. he various aspects disclosed herein encompass present and future known equivalents to the known modules referred to herein by way of illustration. Moreover, while aspects and applications have been shown and described, it would be apparent to those skilled in the art having the benefit of this disclosure that many more modifications than mentioned above are possible without departing from the inventive concepts disclosed herein.

What is claimed is:

1. A method for executing software code associated with scientific or technical documents in a virtual environment, the method comprising:
receiving a scientific or technical document and software code associated with the document, wherein the software code comprises executable code and/or source code;
analyzing the document and/or software code using a first prepared machine learning (ML) model to identify hardware, software and/or runtime configuration parameters for execution of the software code;
configuring the virtual environment based at least on one or more identified hardware, software and/or runtime configuration parameters;
executing the software code in the virtual environment and collecting an execution log of the software code; and
in the event the software code fails to execute correctly,
analyzing the execution log using a second prepared MLM to identify configuration parameters of the virtual environment associated with a cause of failure in execution of the software code,
modifying the identified configuration parameters of the virtual environment, and
executing the software code in the modified virtual environment.

2. The method of claim 1, further comprising: displaying the execution log on a user interface (UI).

3. The method of claim 1 further comprising:
prior to analyzing the document and/or software code using the first prepared MLM, accessing a database containing a plurality of previously analyzed documents and associated software codes with known hardware, software and/or runtime configuration parameters;
comparing, using a third prepared MLM, the document and/or software code with the previously analyzed documents and/or software codes to identify a similar document and/or software code in the database and the associated known configuration parameters; and
configuring the virtual environment based at least in part on one or more of the known configuration parameters of the similar software code from the database.

4. The method of claim 1, wherein the first and second MLMs comprise Large Language Models (LLM).

5. The method of claim 3, wherein the third MLM comprises an autoencoder.

6. The method of claim 1, wherein the virtual environment comprises an isolated, secure virtual environment comprising at least one of a container or a virtual machine.

7. The method of claim 1, wherein configuring the virtual environment based at least on the identified hardware, software and/or runtime configuration, comprises:
identifying and loading into the virtual environment one or more software libraries necessary for execution of the software code.

8. The method of claim 7, wherein executing the software code comprises:
checking the software code for malware and/or security vulnerabilities; and
based on a determination that the software code contains malware and/or serious security vulnerabilities, terminating execution of the software code.

9. A system for executing software code associated with scientific or technical documents in a virtual environment, the system comprising:
at least one memory; and
at least one hardware processor coupled with the at least one memory and configured, individually or in combination, to:
receive a scientific or technical document and software code associated with the document, wherein the software code comprises executable code and/or source code;
analyze the document and/or software code using a first prepared machine learning (ML) model to identify hardware, software and/or runtime configuration parameters for execution of the software code;
configure the virtual environment based at least on one or more identified hardware, software and/or runtime configuration parameters;
execute the software code in the virtual environment and collecting an execution log of the software code; and
in the event the software code fails to execute correctly,
analyze the execution log using a second prepared MLM to identify configuration parameters of the virtual environment associated with a cause of failure in execution of the software code,
modify the identified configuration parameters of the virtual environment, and
execute the software code in the modified virtual environment.

10. The system of claim 9, wherein the least one hardware processor coupled with the at least one memory and is further configured, individually or in combination, to: displaying the execution log on a user interface (UI).

11. The system of claim 9, wherein the least one hardware processor coupled with the at least one memory and is further configured, individually or in combination, to:
prior to analyzing the document and/or software code using the first prepared MLM, accessing a database containing a plurality of previously analyzed documents and associated software codes with known hardware, software and/or runtime configuration parameters;
comparing, using a third prepared MLM, the document and/or software code with the previously analyzed documents and/or software codes to identify a similar document and/or software code in the database and the associated known configuration parameters; and
configuring the virtual environment based at least in part on one or more of the known configuration parameters of the similar software code from the database.

12. The system of claim 9, wherein the first and second MLMs comprise Large Language Models (LLM).

13. The system of claim 11, wherein the third MLM comprises an autoencoder or a transformer-based model.

14. The system of claim 9, wherein the virtual environment comprises an isolated, secure virtual environment comprising at least one of a container or a virtual machine.

15. The system of claim 9, wherein configuring the virtual environment based at least on the identified hardware, software and/or runtime configuration, comprises:
identifying and loading into the virtual environment one or more software libraries necessary for execution of the software code.

16. The system of claim 15, wherein executing the software code comprises:
checking the software code for malware and/or security vulnerabilities; and
based on a determination that the software code contains malware and/or serious security vulnerabilities, terminating execution of the software code.

17. A non-transitory computer readable medium storing thereon computer executable instructions for executing software code associated with scientific or technical documents in a virtual environment, including instructions for:
receiving a scientific or technical document and software code associated with the document, wherein the software code comprises executable code and/or source code;
analyzing the document and/or software code using a first prepared machine learning (ML) model to identify hardware, software and/or runtime configuration parameters for execution of the software code;
configuring the virtual environment based at least on one or more identified hardware, software and/or runtime configuration parameters;
executing the software code in the virtual environment and collecting an execution log of the software code; and
in the event the software code fails to execute correctly,
analyzing the execution log using a second prepared MLM to identify configuration parameters of the virtual environment associated with a cause of failure in execution of the software code,
modifying the identified configuration parameters of the virtual environment, and
executing the software code in the modified virtual environment.

18. The non-transitory computer readable medium of claim 17, wherein the first and second MLMs comprise Large Language Models (LLM).

19. The non-transitory computer readable medium of claim 17, wherein the virtual environment comprises an isolated, secure virtual environment comprising at least one of a container or a virtual machine.

20. The non-transitory computer readable medium of claim 17, wherein executing the software code comprises:
checking the software code for malware and/or security vulnerabilities; and
based on a determination that the software code contains malware and/or serious security vulnerabilities, terminating execution of the software code.
